(19) United States
(12) Patent Application Publication
(10) Pub. No.: US 2022/0126315 A1
(43) Pub. Date: Apr. 28, 2022

(54) DEVICES, SYSTEMS, AND METHODS FOR COATING PRODUCTS

(71) Applicant: Apeel Technology, Inc., Goleta, CA (US)

(72) Inventors: Daniel Ross, Goleta, CA (US); Cody Hegel, Goleta, CA (US); Richard Pattison, Goleta, CA (US)

(21) Appl. No.: 17/451,970

(22) Filed: Oct. 22, 2021

Related U.S. Application Data
(60) Provisional application No. 63/104,600, filed on Oct. 23, 2020.

(51) Int. Cl. B05B 15/00; B05D 1/02; B05B 16/00; B05B 16/20; G05B 15/02

(52) U.S. Cl. CPC B05B 15/00; B05D 1/02; G05B 15/02; B05B 16/20; B05B 16/95

(57) ABSTRACT

A method of treating a perishable item with a coating is described. In one embodiment, the method includes identifying operational parameters associated with a drying tunnel, identifying a desired coating requirement, determining optimal drying tunnel parameters based on the operational parameters and the desired coating requirements, and operating the drying tunnel based on the optimal drying tunnel parameters.

### CLAIM OF PRIORITY

This application claims priority under 35 USC §119(e) to U.S. Patent Application Ser. No. 63/104,600, filed on Oct. 23, 2020, the entire contents of which are hereby incorporated by reference.

### TECHNICAL FIELD

This document describes devices, systems, and methods related to treatment of products, such as devices, systems, and methods for applying a coating to perishable items.

### BACKGROUND

Common products, such as food products, agricultural products, and fresh produce, are susceptible to degradation and decomposition (i.e., spoilage) when exposed to the environment. Product degradation can occur via abiotic means as a result of evaporative moisture loss from an external surface of the agricultural products to the atmosphere, oxidation by oxygen that diffuses into the agricultural products from the environment, mechanical damage to the surface, and/or light-induced degradation (i.e., photodegradation). Furthermore, biotic stressors, such as bacteria, fungi, viruses, and/or pests, can also infest and decompose the agricultural products.

Many products are handled in packing houses, where they are sorted and packaged. On some commercial packing lines, agricultural products may be treated, for example, with waxes which preserve the agricultural products, with sanitizing agents which reduce or eliminate bacteria or other biotic stressors, and/or with solutions that can form protective coatings over the products. While some of these processes may be performed manually, industrial equipment which either automates the processes or more easily facilitates carrying out the processes can be beneficial.

### SUMMARY

Some embodiments described herein include devices, systems, and methods for treating items, such as food products, non-food products, packages, produce, and other perishable or degradable items. Such treatment of items include formation of a coating on surfaces of the items by applying a coating agent onto the items and drying until a layer is formed on the surfaces of the items. In some implementations, the coating agent is a water-based solution. Treatment of product can be performed by various types of drying equipment that facilitate removal of at least some of the water from the solution. In some implementations, heated convection-based systems can be used for drying a coating agent that is applied on the surfaces of items. Sufficient heated evaporative drying of the coating agent on the items can provide various benefits such as improved product consistency and downstream equipment cleanliness and functionality. In some embodiments, drying of the coating agent under predefined parameters can promote a coating having desired properties that enhances performance of the coating in extending shelf-life of the product.

In various example embodiments, drying processing parameters can be selected to achieve desired dryness or other coating characteristics. A water-based coating solution may contain a relatively high moisture content (e.g., higher than some wax-based coating mixtures). The application and drying of the water-based coating solution may be controlled by the residence time within a drying system, air turbulence, temperature, humidity, and other parameters. The water-based coating solution and the application/drying parameters can be selected to provide a coating layer on an item having one or more predetermined characteristics, such as a coating thickness, mosaicity, etc. In some optional embodiments, a drying system can use a relatively high temperature to promote removal of water from the water-based coating solution and facilitate formation of a coating layer having a predetermined coating thickness, mosaicity, etc.

In some optional implementations, a physics-based evaporative drying model can be used to simulate coating characteristics based on one or more parameters. For example, the model may consider air temperatures and/or humidity at different locations of the drying equipment, a residence time of product through the drying equipment, air velocity at different locations of the drying equipment, input characteristics, such as temperature, geometry, mass flow rate of product in the system, ambient temperature and humidity, and other characteristics that affect application and drying of a coating solution on the product. From such data and model evaluations, a set of dry processing parameter requirements can be established and used to operate, select, and/or design a treatment system that meets a desired result (e.g., coating requirements), or set up or modify an existing treatment system (e.g., previously used with different coating compositions).

In some implementations, a desired result includes a desired dryness of the coating agent on the products, coating thickness, coating mosaicity, drying time, mass loss factor of coated product over a predetermined period, etc. In an example embodiment, the treatment system may be designed, configured, and/or operated to balance competing characteristics, such as a coating thickness, coating mosaicity, dryness value, and a throughput requirement (e.g., a mass/volume of items and residence time). For example, some embodiments described herein facilitate coating of a predetermined volume of products relatively quickly, while providing a desired dryness when the products exit a drying tunnel, and while using air/gas having temperatures within a predetermined range (e.g., sufficiently cool to be within a safe range that avoids damaging the products, and sufficiently hot to promote evaporation of water from the product surface/formation of the coating layer). In addition, or alternatively, other characteristics may optionally be determined and controlled at least partially using the model, such as an amount of coating mass, an amount of a solvent (e.g., water), a concentration of the coating solution, an evaporation rate of the solvent (e.g., water), a timeframe for drying without damaging the items, a thickness of the dried coating, etc.

In various example embodiments, operation of a treatment system based on predetermined processing parameters may enable the treatment system to provide drying conditions (e.g., air temperatures, humidity, and/or air velocity at different locations of the drying equipment, a residence time of the items through the drying equipment, and other suitable drying variables) so that a desired result (e.g., dryness, coating thickness, coating mosaicity, mass loss factor of coated product, and/or other coating requirements) can be predictably achieved. Various embodiments described herein facilitate treatment equipment, and operation of treatment equipment, that can reduce waste (e.g., coating waste, water waste, etc.), increase sustainability, and reduce energy consumption and carbon footprint, while providing a coating layer that extends shelf-life of fresh produce and other products. Alternatively, or additionally, some example embodiments facilitate operation without an intentional “knock off” process (e.g., forced blowing liquid coating agent off of the surface of the product) to remove residual moisture.

A desired dryness or drying/coating performance can be represented by one or more factors. In some implementations, a mass loss rate can be used as an indicator of dryness or drying/coating performance. In the context of a product covered by a liquid coating agent, a mass loss rate can relate to a loss of water content from a coated item as the item dries and coating moisture evaporates. In some implementations, the mass loss rate can be described as an evaporation rate, as the mass of the liquid coating on an item is reduced as water in the liquid coating evaporates. In some implementations, a set of dry processing parameter requirements can be determined to achieve a predetermined mass loss rate which represents desired dryness or drying/coating performance.

Some embodiments of the devices, systems, and techniques described herein may provide one or more of the following advantages. First, some embodiments described herein facilitate application of a water-based coating solution to perishable items or other products. The water-based coating solution can be formulated to provide desired coating characteristics on the product to extend shelf-life without substantially affecting the taste, appearance, and tactile feel, for example. In some embodiments, an application system may be operated to provide a coating layer on product that reduces mass loss of the product (e.g., from moisture loss) over an extended period of time.

Second, some embodiments described herein facilitate application and coating of a water-based coating solution in a manner that promotes the effectiveness of the coating layer on the product. For example, some embodiments described herein can facilitate operation of a coating system according to parameters that provide a substantially uniform coating on the product within a desired coating thickness range, coating mosaicity, etc. The thickness range is sufficient to reduce moisture loss from the product and/or provide a protective barrier, while sufficiently thin to allow for natural ripening of the product. In some embodiments, heated drying is facilitated by the treatment system, which can result in a coating having enhanced performance (e.g., as compared to a coating composition formed from drying at ambient temperature). For example, relatively higher drying temperature can decrease the bilayer stacking mosaicity, which can be associated with increased coating performance. The enhanced performance may provide an extended-shelf life of the product (e.g., as compared to a coating having different chemistry, different thickness, or formed at a different drying temperature, etc.).

Third, some embodiments described herein facilitate specification and construction of a drying system, and/or operation of the drying system, based on one or more known inputs of the system. For example, a drying system can be operated according to one or more calculated parameters based on one or more inputs, such as mass flow through the drying system (e.g., of product to be coated), ambient temperature, ambient humidity, post heat exchanger temperature, post heat exchanger humidity, product path air velocity, conveyor length, conveyor width, and heated chamber height, product geometry, density, temperature, thermal conductivity, skin thickness, water content, composition, and surface area, coating solution adherence rate, dynamic viscosity, mass diffusivity, specific heat capacity, latent heat of vaporization, thermal conductivity, density, heat transfer coefficient, and mass transfer coefficient, for example. In some optional embodiments, one or more inputs can be used to operate an application and drying system to predictably treat product to provide desired coating characteristics, reducing the need to continuously alter operating parameters or to select output parameters primarily based on observed characteristics as product passes through the system.

Fourth, some embodiments described herein facilitate energy-efficient application of a coating solution having a relatively high-water content. The system can be controlled with a high degree of consistency to achieve sufficient drying (e.g., evaporation) to provide a coating having desired characteristics, maintain downstream equipment cleanliness, and have a relatively small length/footprint. In some optional embodiments, the drying process occurs substantially or entirely as a result of evaporative drying, facilitating a high percentage of coating solute maintained as a coating layer on the dried product with limited coating solute “knocked-off” or otherwise lost when traversing through the drying system.

Fifth, some embodiments described herein facilitate controlled adjustment/modification to the application and drying systems when one or more inputs change, while maintaining a high degree of predictability in providing a consistent coating having desired characteristics. For example, the system can be adjusted/modified to maintain a desired coating thickness, coating mosaicity, reduce energy-usage, etc. when one or more inputs change, such as a product type, product temperature, mass flow rate, ambient temperature, ambient humidity, etc.

Particular embodiments described herein provide a method for treating, using a treatment apparatus, a plurality of items with a coating mixture, the method including identifying first data associated with the treatment apparatus, identifying second data associated with the plurality of items, identifying third data associated with the coating mixture, determining coating requirements that represent desired properties of coating over the plurality of items, determining treatment processing parameters based on the first data, the second data, the third data, and the coating requirements, setting the treatment apparatus based on the treatment processing parameters, and operating the treatment apparatus to treat the plurality of items with the coating mixture.

In some implementations, the method may optionally include one or more of the following features. The coating mixture may include a coating agent and a solvent. The treatment apparatus may include a conveyor bed configured to support the plurality of items and being rotatable to convey the plurality of items thereon, one or more sprayers configured to apply the coating mixture to the plurality of items on the conveyor bed, one or more blowers configured to blow air onto the plurality of items such that the solvent is at least partially removed from the plurality of items and a protective coating of the coating agent is formed over the plurality of items, and a heat exchanger configured to heat the air at a predetermined temperature higher than an ambient temperature. The first data may include at least one of a mass throughput, the ambient temperature, an ambient humidity, a post heat exchanger temperature, a post heat exchanger humidity, an item path air velocity, a conveyor length, a conveyor width, an air intake rate (e.g., a rate that fresh air is introduced into the system, passively and/or actively), or a heated chamber height. The second data may include at least one of a temperature of the items (e.g., an average or storage temperature of the items), a geometry of the items, a density of the items, a thermal conductivity of the items, a skin thickness of the items, a water content of the items, a composition of the items, or a surface area of the items. The third data may include at least one of an adherence rate, a dynamic viscosity, a mass diffusivity, a specific heat capacity, a latent heat of vaporization, a thermal conductivity, a density, a heat transfer coefficient, or a mass transfer coefficient. Determining treatment processing parameters may include setting a residence time through the treatment apparatus, monitoring the treatment processing parameters, determining whether variables associated with the treatment apparatus meet a threshold, the threshold representative of the coating requirements, and identifying, based on the variables meeting the threshold, the variables as the treatment processing parameters. Determining treatment processing parameters may include predicting the treatment processing parameters based on a treatment processing model with inputs of the first data, the second data, the third data, and the coating requirements. Determining treatment processing parameters may include determining a treatment processing model, fitting the treatment processing model based on the first data, the second data, the third data, and the coating requirements, and predicting the treatment processing parameters based on the fitted treatment processing model. The method may include verifying the treatment processing model based on the operation of the treatment apparatus. The treatment apparatus may include a heated convection-based drying apparatus.

The coating mixture may include a water-based solution. The coating mixture may include a monoglyceride and a fatty acid salt. In some embodiments, the monoglyceride can be present in the mixture in an amount of about 50% to about 99% by mass. In some embodiment, the monoglyceride can be present in the coating mixture in an amount of about 90% to about 99% by mass. In some embodiments, the monoglyceride can be present in the coating mixture in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the coating mixture in an amount of about 1% to about 50% by mass. In some embodiments, the fatty acid salt can be present in the coating mixture in amount of about 1% to about 10% by mass. In some embodiments, the fatty acid salt can be present in the coating mixture in an amount of about 5% by mass. In some embodiments, the fatty acid salt includes a C16 fatty acid salt, a C18 fatty acid salt, or a combination thereof In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the coating mixture further comprises additives, including, but not limited to, cells, biological signaling molecules, vitamins, minerals, acids, bases, salts, pigments, aromas, enzymes, catalysts, antifungals, antimicrobials, time-released drugs, and the like, or a combinations thereof. In some embodiments, the coating mixture can be applied to the product in the form of a solution, suspension, or emulsion with a concentration of the coating mixture of about 1 g/L to about 50 g/L. In some embodiments, a single coating is applied to the product. In some embodiments, multiple coatings may be applied to the product. In some embodiments, 2, 3, 4, or 5 coatings are applied to the product.

The residence time may be between 150 seconds and 180 seconds. The treatment processing parameters may include an average system temperature, the average system temperature may be 65° C. (e.g., about 65° C., plus or minus 5° C.). The treatment processing parameters may include a product path air velocity, the product path air velocity between 3 m/s and 6 m/s. The treatment processing parameters may include a relative humidity within the system, the relative humidity less than 15%. The coating requirement may include a coating thickness, coating mosaicity, bilayer stacking mosaicity, etc. The items may be perishable items. The items may be produce items. The items may be non-edible items. The items may be selected from the group consistent of avocados, lemons, oranges, apples, plums, grapefruits, peaches, citrus, berries, peppers, tomatoes, leafy produce, fruits, vegetables, legumes, nuts, flowers, processed food items, candy, vitamins, and nutritional supplements.

Particular embodiments described herein provide a method for treating an item with a coating mixture, including identifying operational parameters associated with a drying tunnel, identifying a desired coating requirement, determining optimal drying tunnel parameters based on the operational parameters and the desired coating requirements, and operating the drying tunnel based on the optimal drying tunnel parameters. In some implementations, the coating requirement may include a coating thickness, coating mosaicity, bilayer stacking mosaicity, etc.

Particular embodiments described herein provide a method for treating an item with a coating mixture, including determining optimal drying tunnel parameters that enables a drying tunnel to generate a desired coating on the item and operating the drying tunnel based on the optimal drying tunnel.

Particular embodiments described herein provide a method for treating an item with a coating mixture. The method may include means for determining drying tunnel parameters that enables a drying tunnel to generate a coating on an item having one or more coating requirements. In some implementations, the method may include means for operating the drying tunnel based on the drying tunnel parameters.

Particular embodiments described herein provide a treatment system for drying coated items. The treatment system may include a drying tunnel controlled by a drying tunnel controller. The drying tunnel controller may be configured to maintain one or more treatment processing parameters within a predetermined range.

In some implementations, the method may optionally include one or more of the following features. The one or more treatment processing parameters may include an average system temperature. The average system temperature may be greater than 65° C. The one or more treatment processing parameters may include a conveyor speed. The conveyor speed may be controlled to provide a product residence time within the drying tunnel between 90 seconds and 240 seconds. The one or more treatment processing parameters may include a product path air velocity. The product path air velocity may be maintained between 3 m/s and 6 m/s. The one or more treatment processing parameters may include an average relative humidity. The average relative humidity may be controlled to be less than 15%. The treatment processing parameters may be selected based on a temperature of the products before entering the drying tunnel, a product geometry, a product density, a product thermal conductivity, a product skin thickness, a product water content, a product composition, and a product surface area.

The products may include a liquid coating. The coating may include a water-based solution. The coating mixture may include a monoglyceride and fatty acid salt. The coating mixture may include a monoglyceride and a fatty acid salt. In some embodiments, the monoglyceride can be present in the mixture in an amount of about 50% to about 99% by mass. In some embodiment, the monoglyceride can be present in the coating mixture in an amount of about 90% to about 99% by mass. In some embodiments, the monoglyceride can be present in the coating mixture in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the coating mixture in an amount of about 1% to about 50% by mass. In some embodiments, the fatty acid salt can be present in the coating mixture in amount of about 1% to about 10% by mass. In some embodiments, the fatty acid salt can be present in the coating mixture in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the coating mixture further comprises additives, including, but not limited to, cells, biological signaling molecules, vitamins, minerals, acids, bases, salts, pigments, aromas, enzymes, catalysts, antifungals, antimicrobials, time-released drugs, and the like, or a combinations thereof. In some embodiments, the coating mixture can be applied to the product in the form of a solution, suspension, or emulsion with a concentration of the coating mixture of about 1 g/L to about 50 g/L. In some embodiments, a single coating is applied to the product. In some embodiments, multiple coatings may be applied to the product. In some embodiments, 2, 3, 4, or 5 coatings are applied to the product.

The treatment processing parameters may be configured to form a dried coating on the items having a thickness between 0.1 microns and 5 microns. In some embodiments, the dried coating on the items may have a thickness between 0.1 microns and 20 microns. The treatment processing parameters may be configured to form a dried coating on the items that exhibits bilayer stacking mosaicity. The items may be perishable items. The items may be produce items, non-edible items, etc. The items may be selected from the group consistent of apples, citrus, berries, melons, peppers, tomatoes, leafy produce, fruits, vegetables, legumes, nuts, flowers, processed food items, candy, vitamins, nutritional supplements, and the like. In some embodiments, the item may be selected from the group consisting of an apple, an apricot, an avocado, a banana, a blueberry, a bayberry, a cherry, a clementine mandarin, a cucumber, a custard apple, a fig, a grape, a grapefruit, a guava, a kiwifruit, a lime, a lychee, a mamey sapote, a mango, a melon, a mountain papaya, a nectarine, an orange, a papaya, a peach, a pear, a pepper, a persimmon, a pineapple, a plum, a strawberry, a tomato, a watermelon, and combinations thereof

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-B illustrate an example treatment system.

FIGS. 2 illustrates an example treatment parameter system.

FIG. 3 illustrates an example conveyor system.

FIG. 4A illustrates another example conveyor system.

FIG. 4B schematically illustrates an example treatment apparatus.

FIGS. 5A-C illustrate an example surface drying model.

FIG. 6 is a flowchart of an example process for determining variables for an optimal performance of a drying apparatus.

FIG. 7 is a flowchart of an example process for fitting a product dryer model.

FIG. 8A-I illustrate an example experiment based on the process of FIG. 7.

FIG. 9 is a flowchart of another example process for fitting a product dryer model.

FIG. 10A-F illustrate an example experiment based on the process of FIG. 9.

FIG. 11 illustrates an example thermodynamic model.

FIG. 12 illustrates a change in a remaining water mass percentage as product is transported through a tunnel.

FIGS. 13A-D show an example report of proposed customization of drying equipment that has been analyzed.

FIG. 14 is a block diagram of computing devices that may be used to implement the systems and methods described in this document.

FIG. 15 is a bar chart comparing mass loss factor to treatment conditions.

FIG. 16 is a scatter plot chart comparing respiration to ripening time.

FIG. 17 is a scatter plot chart comparing firmness to ripening time.

FIG. 18 is a scatter plot chart comparing % incidence of shrivel to days of storage at ambient conditions.

FIG. 19 a bar chart comparing % heat damage to treatment conditions.

FIG. 20 is a scatter plot chart comparing cucumber surface temperature to drying room temperature set point.

FIG. 21 is a bar chart comparing percent shriveled tips and temperature outside of the drying room to stoppage time.

FIG. 22 is a bar chart comparing percent shriveled tips and % samples that are sellable to stoppage time.

FIG. 23 is a bar chart comparing mass loss rate and temperature outside of the drying room to treatment conditions.

FIG. 24 is a scatter plot chart comparing % unsalability of samples to time post-treatment.

FIG. 25 is a bar chart comparing incidence of skin desiccation and temperature of the fruit existing the drying tunnel to treatment conditions.

### DETAILED DESCRIPTION OF ILLUSTRATIVE EMBODIMENTS

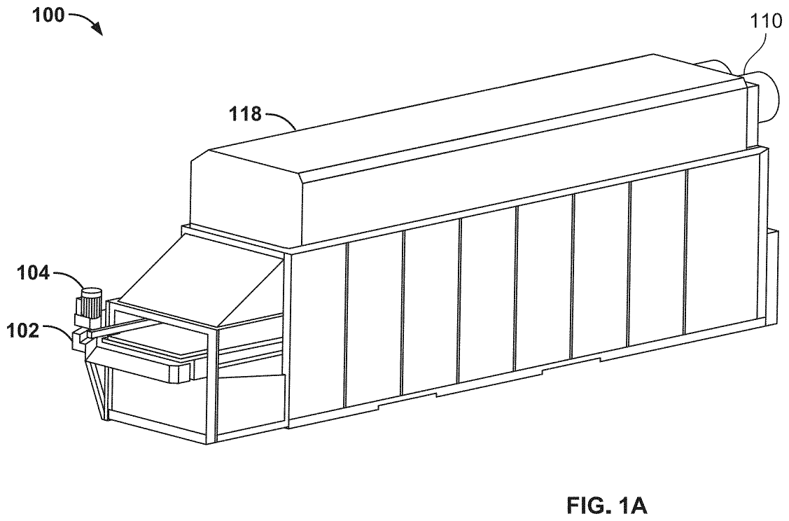

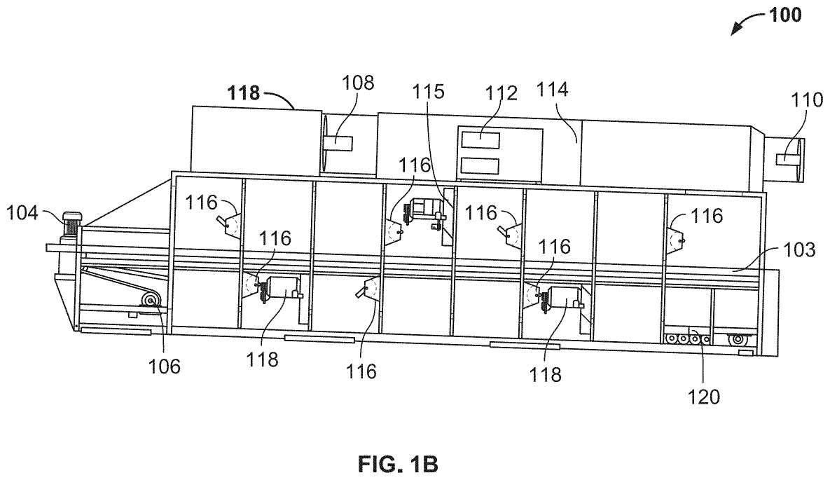

Referring to FIGS. 1A-B, an example treatment apparatus 100 is shown. The treatment apparatus 100 can include a drying apparatus. The treatment apparatus 102 is configured to treat items, such as food products, harvested produce or other agricultural products, seeds, non-food items, packaging, etc., to form a coating (e.g., solvents, solutions, other coatings, etc.). By way of example, the treatment apparatus 100 can be configured or adapted to treat (e.g., coat, dry, etc.) product such as apples, citrus, berries, melons, peppers, tomatoes, leafy produce, fruits, vegetables, legumes, nuts, flowers, processed food items, candy, vitamins, nutritional supplements, and the like. In some embodiments, the treatment apparatus 100 can be configured or adapted to treat products selected from the group consisting of an apple, an apricot, an avocado, a banana, a blueberry, a bayberry, a cherry, a clementine mandarin, a cucumber, a custard apple, a fig, a grape, a grapefruit, a guava, a kiwifruit, a lime, a lychee, a mamey sapote, a mango, a melon, a mountain papaya, a nectarine, an orange, a papaya, a peach, a pear, a pepper, a persimmon, a pineapple, a plum, a strawberry, a tomato, a watermelon, and combinations thereof.

In an example embodiment, treatment apparatus 100 facilitates application of a water-based coating solution to produce a coating layer having one or more desired characteristics. The treatment apparatus 100, and one or more of its operating parameters, may facilitate drying of a relatively high-water content of the coating solution while producing a coating having characteristics within predetermined ranges, such as a predetermined coating thickness, coating mosaicity, etc. In some embodiments, relatively high heat may be applied to the product to facilitate evaporation of a substantial portion of the water content of the coating solution, without damaging the product (e.g., which may be sensitive to prolonged exposure to heat, or temperatures above a threshold value).

The treatment apparatus 100 can include a drying tunnel 118 and a conveyer system 102 configured to move product through the drying tunnel 118. The treatment system can further be used with, or include, an infeed system, a bed, one or more coating applicators, and/or a packing station. The infeed system can include a loading system on which items are loaded manually or automatically. In some implementations, the items can be sorted, for example, by size, color, and/or stage of ripening at the infeed system. Alternatively, the items can be sorted before arriving at the infeed system. The bed is configured to transport items at the treatment apparatus 100, such as from the infeed system to the packing station through different components of the treatment apparatus. The bed can be of various types, such as a brush bed, rolling translating conveyer, etc. The applicators can operate to apply a treatment agent on the items being transported on the bed. Alternatively or in addition, the items may be coated with the treatment agent by being submerged in the treatment agent. The treatment agent may include a coating agent. The drying tunnel 118 can operate to remove moisture and dry the coating agent applied on the items. The packing station can facilitate packing the treated items for transport.

The drying tunnel can include various components to facilitate drying the coating agent on the items. In some implementations, the components may include heated air blowers that are located over drying brushes and drying tunnels with roller conveyors. For example, the drying tunnel can include a blower that pushes hot air into the system and fans along the length providing additional airflow. In another example, the drying tunnel may uses a pressure buildup with a perforated plate to supply high velocity air across the product path. In some embodiments, temperature set points for the drying tunnels are between 45-95° C., 50-90° C., 55-85° C., or 65-80° C. The drying systems may use direct fire burners. Anodized aluminum rollers may be used. The drying tunnels may include air recirculation, and optionally humidity control systems with the addition of a ventilation duct and modulating exhaust. High pressure blowers may be provided to supply air to a perforated plate. This may provide a high velocity of air across the product path. Air may be recirculated from both sides of the tunnel, for example.

The treatment apparatus 100 can utilize the conveyor system 102 for moving the items while a coating mixture is applied to the items and/or while the items are subsequently dried. In some implementations, the conveyor system 102 includes a conveyor bed configured to cause the items to simultaneously rotate as they move from one section to another, facilitating complete surface coverage and/or drying. Alternatively, or additionally, the treatment apparatus 100 can also include other components such as sprayers and/or blowers that directly treat and/or facilitate drying of the items while they are on the bed of the conveyor system 102. For example, one or more sprayers can be mounted over the bed and used to spray liquid droplets of solvent or solution on the items as the items passes the sprayers. The liquid droplets can, for example, include a sanitizing agent such as ethanol. The liquid droplets can alternatively include water, combinations of ethanol and water, or other solvents suitable for treatment of the items. As further described below, the liquid droplets can, for example, include a coating agent which forms a protective coating over the items on which it is sprayed. Alternatively, the sprayers can indirectly treat or coat the items by saturating rollers over which the items moves. The rollers can move independently from the belt or chain drive system that moves the conveyor, rotating the items, such that the rollers act to coat the items with the solution thereon.

Other types of components for treating the items on the conveyor system bed can also be provided at the treatment apparatus 100. For example, fans, blowers, or air knives can be mounted with their exhaust over the bed of the conveyor system 102 and used to blow air or other gasses (e.g., nitrogen gas or air/nitrogen mixtures) onto the items in order to facilitate drying of the items. The treatment apparatus 100 can include a mixing system for preparing solutions or suspensions that are sprayed onto the items, as well as a liquid delivery system that transports the solution/suspension from the mixing system to the sprayers at a suitable pressure and flow rate.

The conveyer system 102 of treatment apparatus 100 can include a motor 104 and a take-up roller 106 configured to operate the conveyor system 102. A roll cleaning assembly 120 can be provided to clean a bed (and rollers) of the conveyor system 102.

The treatment apparatus 100 can further include various components for circulating conditioned air for drying items that are transported by the conveyor system 102. For example, the drying apparatus 100 can include an intake blower 108 configured to draw air into the drying apparatus 100, and an exhaust blower 110 configured to discharge air from the drying apparatus 100. The drying apparatus 100 can further include a heating element 112 to adjust a temperature of air circulating in the drying apparatus 100. One or more hot air recirculation control dampers 114 can control volume of recirculated air and/or facilitate control of one or more air temperature and humidity values. The treatment apparatus 100 can include one or more airflow control panels 116 that are disposed at different locations in the apparatus and configured to control airflow at such locations. The drying apparatus 100 can include one or more fan assemblies 115 that are disposed at different locations in the apparatus and configured to drive air flow at desired directions.

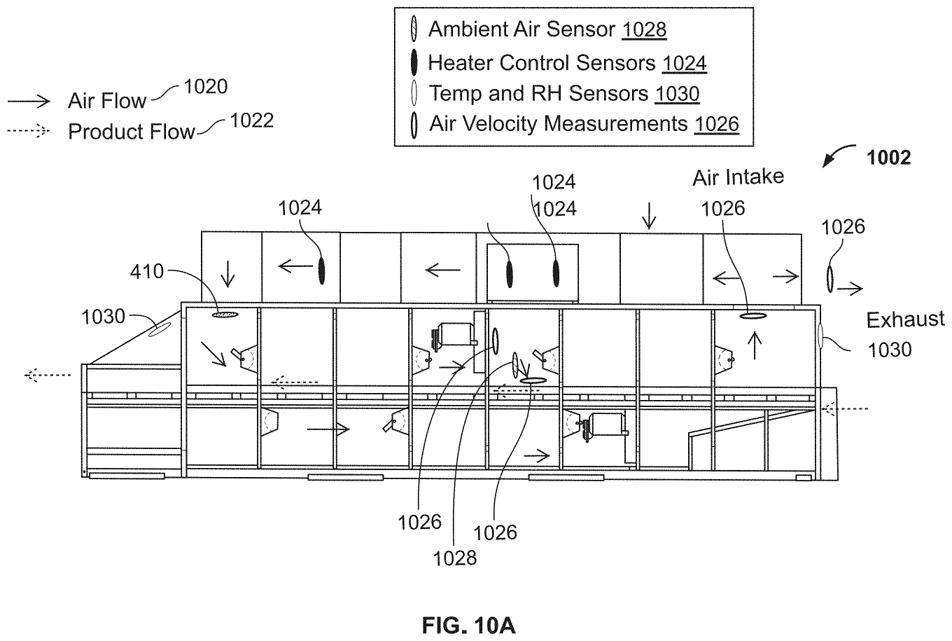

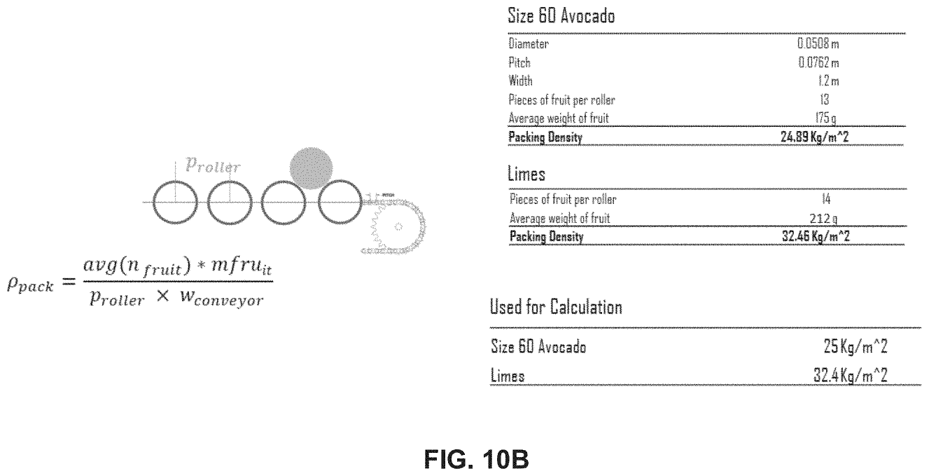

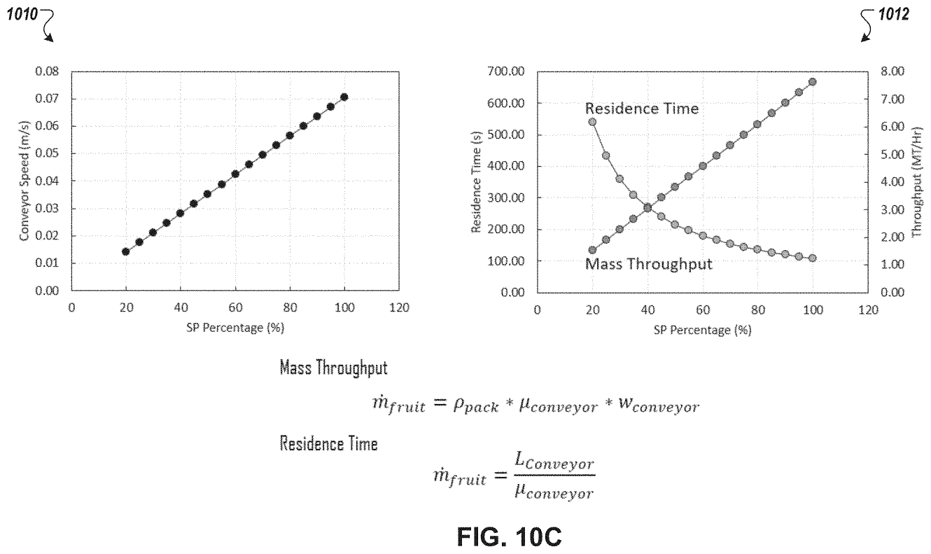

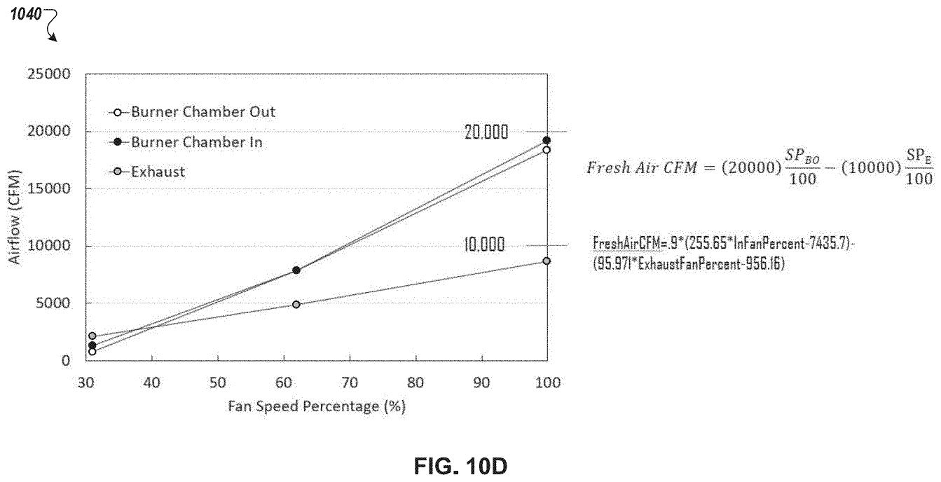

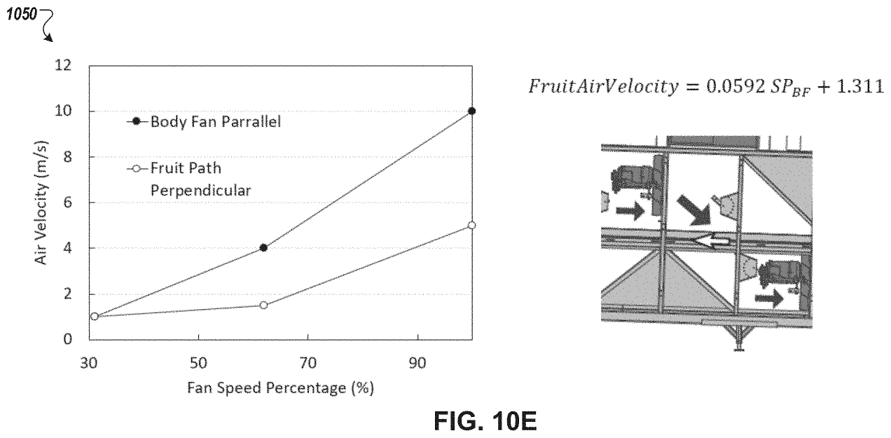

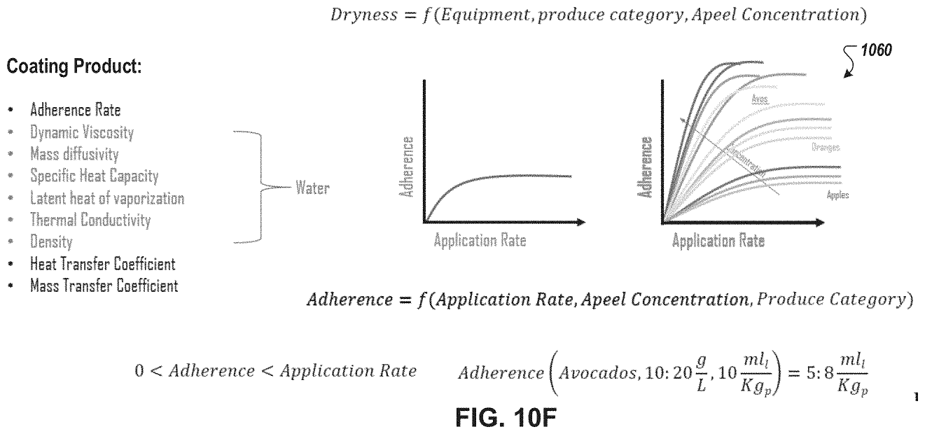

In some implementations, the treatment apparatus 100 can include various sensors to measure various parameters that can be used to determine a drying performance in the apparatus. The treatment apparatus 100 can include temperature sensors, air velocity sensors, and heater control sensors, as illustrated in FIG. 10C, for example.

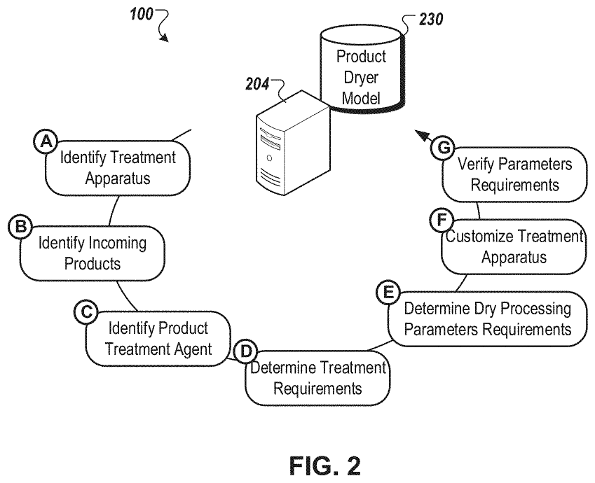

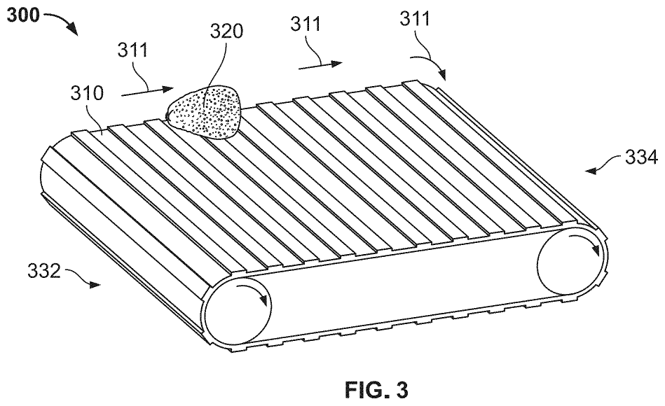

One or more processing parameters of treatment apparatus 100 may be determined and/or controlled by treatment parameter system 204 (FIG. 2). Treatment parameter system 204 facilitates determination of one or more processing parameters (e.g., drying parameters) for the treatment apparatus 100 to achieve a desired result (e.g., dryness, coating thickness, coating mosaicity, coating performance, etc.) with a particular coating product and processing inputs. For example, various parameters such as mass flow through the drying system (e.g., of product items to be coated), ambient temperature, ambient humidity, post heat exchanger temperature, post heat exchanger humidity, product path air velocity, conveyor length, conveyor width, and heated chamber height, product geometry, density, temperature, thermal conductivity, skin thickness, and surface area, coating solution adherence rate, etc. can be controller or accounted for during application of a coating solution by treatment apparatus 100.

The processing parameters that define a coating application and drying process, together with the coating solution chemistry, characteristics of the item being coated, and other factors, may affect the performance of the dried coating on the item. For example, the processing parameters that define a coating application and drying process may be controlled to produce a dried coating on an item having a predictable thickness. An example coating composition may provide enhanced performance in extending the useful shelf-life of product when the dried coating thickness, coating mosaicity, and/or other coating parameters are within a predetermined range. The predetermined thickness range may allow for some gas transport (e.g., and thus does not create an anaerobic environment for the item), while reducing moisture loss from the item as it ages. A dried coating layer that allows some gas transport can thus extend the shelf-life of the item to a greater extent than a dried coating layer that prevents all gas transport across the coating layer. In an example embodiment (e.g., using a coating composition as described herein), a dried coating layer thickness of about 1 micron can effectively prevent moisture loss from the item, without blocking beneficial gas transport. In various example embodiments, the dried coating layer thickness is between about 0.1 microns and 5 microns, 0.3 microns and 3 microns, 0.5 microns and 2 microns, or about 1 micron. In alternative example embodiments, the dried coating layer thickness is between about 0.1 microns and 20 microns, 3 microns and 16 microns, 5 microns and 10 microns, or about 10 microns. A coating layer have a desired coating thickness, coating mosaicity, etc., within a predetermined range can be predictably provided by controlling one or more parameters of the application and drying process. One or more processing parameters of treatment apparatus 102 may thus be controlled to facilitate formation of a dried coating layer having a thickness within a predetermined range.

Treatment parameter system 204 may facilitate determination of a set of suitable processing parameters for operation of treatment apparatus 100. Various aspects of the drying process may have competing parameters (e.g., such that a change in one parameter may affect or require corresponding changes to one or more other parameters). For example, a coating composition having a relatively high moisture content may be more quickly evaporated using a high temperature drying system. Additional heat may be appropriate when the item to be coated has been stored in a refrigerated environment. On the other hand, an item to be treated may have a maximum threshold temperature or heating period that it can be subjected to without damage. As another example, relative air velocity across a product path within the drying system may facilitate convective evaporation of moisture from the liquid coating composition, but in some embodiments may be desirably maintained below a threshold value that causes a “knock off” effect in which coating composition is blown off the surface. One or more additional factors may in turn be controlled to facilitate drying and formation of a desired coating layer. Treatment apparatus and treatment parameter system 204 may facilitate predictably balancing such competing factors to repeatably produce a dried coating having consistent characteristics and performance, as described in further detail herein.

In some examples, lower relative humidity within the treatment apparatus can increase the rate of evaporation of moisture from the liquid coating composition, which can be promoted by a relatively high rate of fresh air turnover through the system. The amount of fresh air turnover, in turn, can affect the energy input required to maintain a particular temperature through the system. The airflow and temperature may be balanced in part of operational constraints, such as physical space constraints, energy constraints, etc.

In some implementations, the treatment apparatus 100 can include repacking equipment, packing equipment, and other suitable equipment, apparatuses, devices, or systems for coating items, such as harvested produce or other agricultural products. In various implementations, the processing parameters (e.g., determined using treatment parameter system 204) can be used to configure or customize the treatment apparatus 100. For example, an existing treatment apparatus (e.g., at packing facility) may be retrofitted and/or configured to operate using the determined processing parameters.

The treatment parameter system 204 can be used to identify the treatment apparatus 100, such as a configuration, performance characteristic, capacity, etc. of treatment apparatus 100 (Step A). In some implementations, the system 204 can be used to identify drying apparatus characteristics (e.g., specifications of the drying tunnel 118) in the treatment apparatus 100. The system 204 can be used to identify incoming products (Step B). For example, the system 204 can be used to determine the products that are being, or will be, loaded on the infeed system.

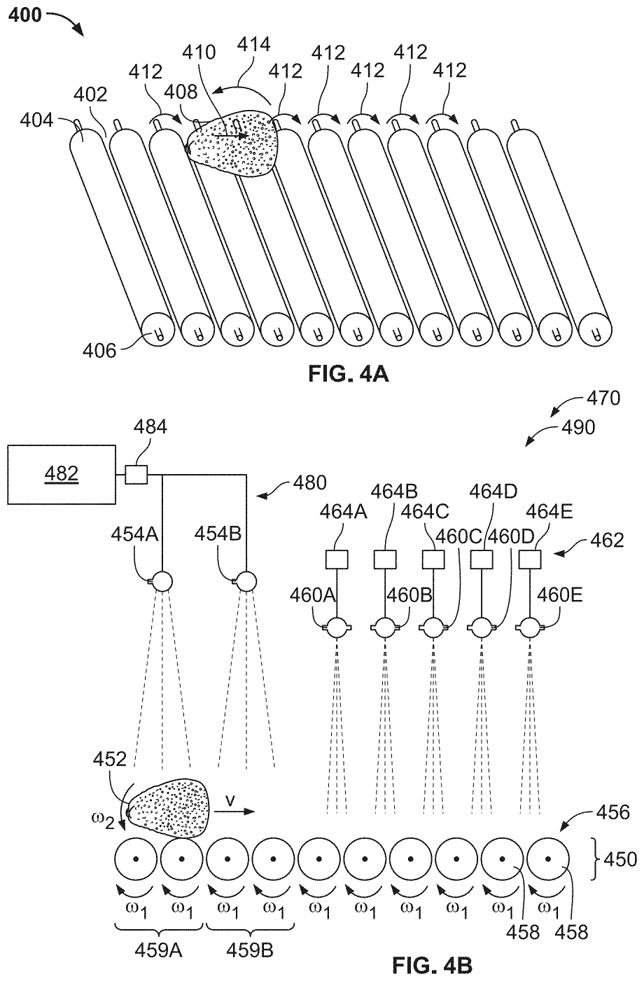

The system 204 can be used to identify a product treatment agent (Step C). The product treatment agent can include a coating agent for coating the surface of the products. Various coating agents can be used. An example of the coating mixture includes a water-based coating solution. Examples of the coating mixture are described further herein, for example with reference to FIGS. 4A-B.

The system 204 can be used to determine one or more treatment requirements (Step D). The treatment requirements may include a desired dryness of the coating mixture on the items. In addition, or alternatively, the treatment requirements may include a combination of multiple requirements (e.g., coating requirements) which may or may not compete with each other. For example, the treatment requirements may need to achieve a balance of competing requirements, such as a dryness requirement and a throughput requirement (a volume of items and residence time). For example, the treatment equipment may need to treat a predetermined volume of products quickly, while providing a desired dryness on the items using air having temperatures within a predetermined range (e.g., that facilitates evaporative drying while below a threshold temperature the products can be subjected to without damage to the products). In addition or alternatively, other requirements may be considered, such as an amount of mass, an amount of a solvent (e.g., water) required for the application process, a concentration of the coating solution to apply, an evaporation rate of the solvent (e.g., water) off the items, or a timeframe for drying without damaging the products, a thickness of the coating on the products, etc.

The system 204 can operate to determine requirements for drying processing parameters (Step E). In some implementations, the drying processing parameters requirements are determined to generate a desired result (e.g., dryness and/or other drying/coating performance (coating requirements)) of the incoming products that are coated with the coating mixture. Various parameters associated with the treatment apparatus 100 can be subject to the drying processing parameters requirements. For example, the drying processing parameters may include air temperatures, humidity, and/or air velocity at different locations of the drying equipment, and/or a residence time of the items through the drying equipment.

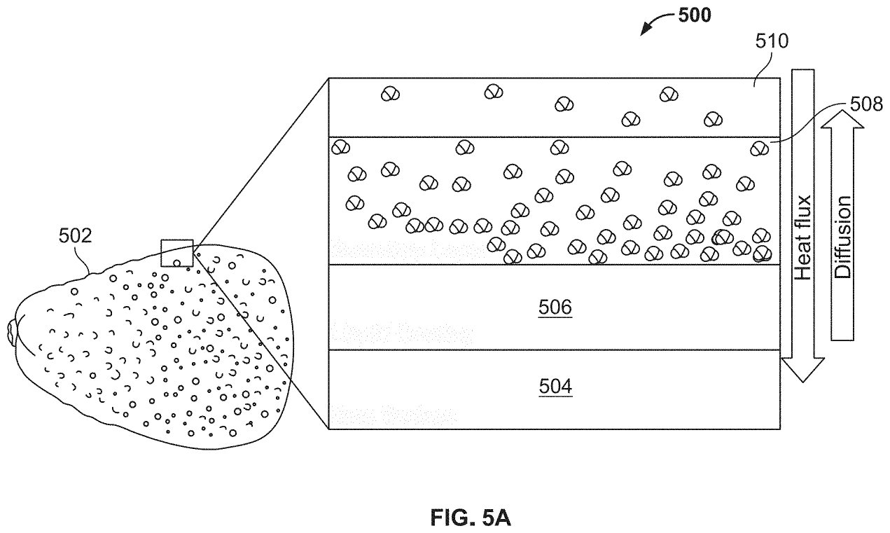

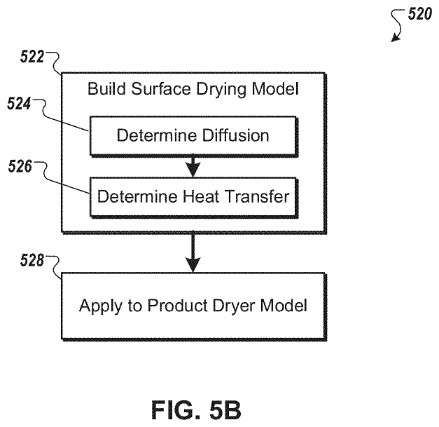

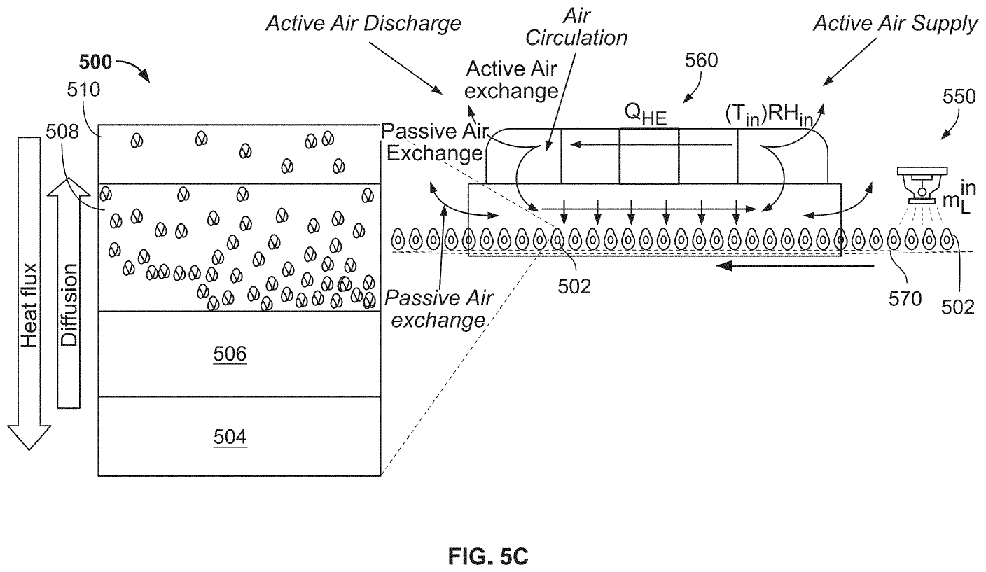

In some implementations, a product drying model can be used to determine such drying processing parameters requirements. The product drying model can be established based on a surface drying model (e.g., FIGS. 5A-C) and data collected from actual and/or experimental operations of drying equipment. The product drying model can be used to simulate a variety of potential environmental and supplier-based scenarios, and used to select or design a treatment system (e.g., a drying tunnel) that meets a desired result (e.g., coating requirements), or set up or modify an existing treatment system to adapt to the desired result. In some implementations, the product drying model can be stored in a dryer model database 230 and retrieved by, for example, the system 204 to predict optimal parameters for customizing an existing drying apparatus or for selecting or designing a new drying apparatus for a desired drying performance (including a coating performance).

The system 204 can be used to customize the treatment apparatus 100 (Step F). The treatment apparatus 100 can be customized based on the drying processing parameters requirements that are determined as generating the desired results. For example, various components (e.g., air heaters, fans, etc.) in the drying equipment (e.g., the drying tunnel) can be set up and/or operated according to the drying processing parameters requirements. In alternative implementations, the drying processing parameters requirements can be used to select or design a treatment apparatus for the particular incoming products.

In some implementations, the system 204 can operate to verify the drying processing parameters requirements (Step G), such as based on measured or observed characteristics of a dried coating on products processed using the processing parameters. Such verified data can be further used to update the drying processing parameters requirements, and/or the product drying model.

Treatment apparatus 100 can be configured and/or controlled to operate according to one or more processing parameters that predictably provide a desired coating composition (e.g., such as one or more processing parameters determined using system 204). In an example embodiment, coating composition is water-based, having greater than 30%, greater than 50%, greater than 75%, greater than 85%, greater than 90%, greater than 95% greater than 98% or greater water content. In some embodiments, the concentration of coating agent can be greater than about 10%, 15%, 20%, 25%, 30%, 35%, 40%, 45%, 50%, 55%, 60%, 65%, 70%, 75%, 80%, 85%, 90%, or 95% of the saturation limit of water at ambient temperature and pressure. One or more parameters of treatment apparatus 102 may be controlled to provide a desired residence time of coated items within the drying environment. For example, the residence time may be between 30 seconds and 540 seconds, 60 seconds and 360 seconds, or 150 seconds and 180 seconds, with an average system temperature greater than 40° C., greater than 45° C., greater than 50° C., greater than 55° C., greater than 60° C., greater than 65° C., greater than 70° C., greater than 75° C., greater than 80° C., greater than 85° C., or 90° C. or greater. In some implementations, the residence time may be relatively shorter and the average system temperature may be relatively higher. In some implementations, the residence time may be relatively longer and the average system temperature may be relatively lower. Alternatively, or additionally, one or more parameters may be controlled to provide a relative humidity within the system of less than 30%, less than 20%, or less than 15%. In some embodiments, a predetermined humidity level may be maintained by providing a large turnover of fresh air (e.g. purging of moist air that carries away the evaporated water). The product path air velocity may also be controlled. In example embodiment, the product air path velocity is between 2 m/s and 8 m/s, 2.5 m/s and 7 m/s or between 3 m/s and 6 m/s. Alternatively, or additionally, the system may be configured to rotate the items as the items translate through the system, while preserving a mono layer of items. Accordingly, in some example embodiments, the treatment apparatus 100 may be controlled to apply a water-based coating composition having a relatively high water content to coat items, and pass the coated items (while the coated items rotate) through a drying environment over a residence time of about 150-180 seconds, at a minimum average system temperature of about 65° C., with a humidity of 15% or less, and a product path air velocity of about 3 m/s to 6 m/s.

The treatment apparatus 100 can be controlled to produce a coating on the products having one or more predetermined characteristics. For example, the drying temperature (e.g., average system temperature) can impact the mosaicity of the coating, and in turn the coating performance in achieving an appropriate mass loss rate/extended product shelf-life. Mosaicity is a measure of the probabilities of relative orientation of the bilayers relative to the plane of the substrate. Bilayer stacking mosaicity is also a type of crystal defect that creates a pathway for water and gas transport. Lower mosaicity means that more of the bilayers are sitting more parallel to the plane of the substrate. Increase in drying temperature drastically decreases the bilayer stacking mosaicity, and thus leads to increased barrier performance. Relatedly, the drying temperature can affect the gas diffusion ratio. In some implementations, such features can be characterized by an X-ray scattering image of the applied coating.

FIG. 3 illustrates an example conveyor system 300. In some embodiments, one or more features of the conveyor system 300 can be used to implement the transfer conveyor 102 of FIGS. 1A-1B. The conveyor system 300 can include a bed 310 that moves in a direction 311. One or more items 320 placed on the upper surface of the bed 310 can be transported from a first side 332 to a second side 334 of the conveyor system 300. In some implementations, the bed 310 can include a sanitary material, or a material that can be readily sanitized or disinfected, to prevent the items from being exposed to or infected by bacteria, fungi, viruses, or other biotic stressors. In some implementations, the items 320 can remain stationary with respect to the bed 310 during transport. For example, the items 320 do not roll or slide as they are transported on the bed 310.

FIG. 4A illustrates another example conveyor system 400 that is capable of rotating items (e.g., produce, perishable items, or other objects) as the items move from one side of the bed to the other. The conveyor system 400 includes a bed 402 that includes a plurality of rotational devices 404. During operation of the conveyor system 400, each rotational device 404 is rotated (e.g., about axes 406) in a forward rotational direction 412. In an example embodiment, rotation device 404 does not otherwise have any translational motion. Items 408 that are placed on the bed 402 translate horizontally in a forward conveying direction 410 while also rotating in a rearward rotational direction 414. In some implementations, the rotational devices 404 can be cylindrical rollers. Alternatively, the rotational devices 404 can include brush rollers that each have brushes (e.g., extending out from the axis 406). Alternatively, or additionally, the bed 402 can use a combination of cylindrical and brush rollers, and/or can include different types of brush bed rollers at one or more different locations.

The rotational motion 414 of the item 408 on the bed 402 results from the rotational motion 412 of the rotational devices 404. In some implementations, depending on the specific design of the rotational devices 404 and the shape and size of the item 408, the translational motion 410 of the item 408 may or may not be caused by the rotational motion 412 of the rotational devices 404. For example, where the rotational devices 412 are solid rollers and the item 408 is large and/or irregularly shaped, the rotational motion 412 of the rotational devices 404 can also cause the item 408 to translate horizontally. However, if the rotational devices 412 are brush rollers and the item 408 is relatively small and/or fairly regularly shaped, the rotational motion 412 of the rotational devices 404 may not independently cause the item 408 to translate in the forward conveying direction 410. The horizontal translation of items 408 across the bed 402 can be facilitated by continuously/consistently loading items onto the bed 402, such that the newly added items push the previously loaded items ahead in the forward conveying direction 410. For example, during operation of the conveyor system 400, items 408 are continuously loaded onto the bed 402 via a second conveyor system (e.g., the conveyor system 300 shown in FIG. 3) placed in-line with the conveyor system 400. The average speed at which items translate laterally can be determined by the mass flow rate of items delivered onto the bed 402.

FIG. 4B schematically illustrates an example treatment apparatus 470 that can be used to treat items (e.g., produce, agricultural products, or other perishable items). In some embodiments, one or more features of the treatment apparatus 470 can be used to implement the treatment apparatus 100, 200. The treatment apparatus 470 can include a conveyor system 450, such as the conveyor system 400 of FIG. 4A, the conveyor system 300 of FIG. 3, etc. The treatment apparatus 470 also includes sprayers 454A-454B over at least a first portion of the bed and blowers 460A-460E over at least a second portion of the bed. Items 452 that are placed on the bed are first coated with liquid from the sprayers 454A-454B, and then pass under the blower exhausts 460A-460E which facilitate controlled drying of the items 452. In example embodiment, the items 452 are first coated by sprayers 454A-454B (e.g., completely coated), and then subsequently subjected to exhaust by blower exhausts 460A-460E. Note that sprayers 454A and 454B can each include multiple spray heads, and blower exhausts 460A, 460B, 460C, 460D, and 460E can each be connected to individual blowers or can all be connected to a single blower. Alternatively, or additionally, as discussed above, the sprayers can saturate the rollers with a coating solution and the saturated rollers coat the product as it rotates over the rollers.

The treatment apparatus 470 facilitates application and formation of protective coatings (e.g., edible coatings) on items 452. For example, while the item 452 moves (e.g. laterally in the view of FIG. 4B) along bed 456 and is simultaneously rotated by the rollers 458, sprayers 454A-B can spray or otherwise distribute droplets of a treatment agent (e.g., a solution, suspension, emulsion, etc.) over the surface of the item 452. The treatment agent can include a coating agent (e.g., a solute) in a solvent. Once the item is covered with the treatment agent, it passes beneath the blower exhausts 460A-E, which facilitate controlled removal (e.g., via evaporation) of the solvent while the item 452 is on the conveyor system 450, thereby allowing the solute composition (e.g., the coating agent) to remain on the surface of the item 452 to form the protective coating.

The protective coating formed from the solute composition can be used to prevent food spoilage due to, for instance, moisture loss, oxidation, or infection by a foreign pathogen. The solvent in which the coating agent is dissolved or suspended can, for example, be water, an alcohol (e.g., ethanol, methanol, isopropanol, or combinations thereof), acetone, ethyl acetate, tetrahydrofuran, or combinations thereof. The coating agent can, for example, include monoacylglycerides, fatty acids, esters (e.g., fatty acid esters), amides, amines, thiols, carboxylic acids, ethers, aliphatic waxes, alcohols, fatty acid salts, organic salts, inorganic salts, or combinations thereof. In some implementations, the coating agent includes monomers, oligomers, or combinations thereof, including esters or salts formed thereof In some particular implementations, the solutions/suspensions/colloids include a wetting agent or surfactant which cause the solution/suspension/colloid to better spread over the entire surface of the substrate during application, thereby improving surface coverage as well as overall performance of the resulting coating. In some particular implementations, the solutions/suspensions/colloids include an emulsifier which improves the solubility of the coating agent in the solvent and/or allows the coating agent to be suspended or dispersed in the solvent. The wetting agent and/or emulsifier can each be a component of the coating agent or can be separately added to the solution/suspension/colloid.

In various embodiments, the coating agent can include a monoglyceride and a fatty acid salt. In some embodiments, the monoglyceride can be present in the coating agent in an amount of about 50% to about 99% by mass. In some embodiment, the monoglyceride can be present in the coating agent in an amount of about 90% to about 99% by mass. In some embodiments, the monoglyceride can be present in the coating agent in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the coating agent in an amount of about 1% to about 50% by mass. In some embodiments, the fatty acid salt can be present in the coating agent in amount of about 1% to about 10% by mass. In some embodiments, the fatty acid salt can be present in the coating agent in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the coating agent further comprises additives, including, but not limited to, cells, biological signaling molecules, vitamins, minerals, acids, bases, salts, pigments, aromas, enzymes, catalysts, antifungals, antimicrobials, time-released drugs, and the like, or a combinations thereof. In some embodiments, the coating agent can be applied to the product in the form of a solution, suspension, or emulsion with a concentration of the coating agent of about 1 g/L to about 50 g/L. In some embodiments, a single coating is applied to the product. In some embodiments, multiple coatings may be applied to the product. In some embodiments, 2, 3, 4, or 5 coatings are applied to the product.

The solvent to which the coating agent and wetting agent (when separate from the coating agent) is added can, for example, be water, methanol, ethanol, isopropanol, butanol, acetone, ethyl acetate, chloroform, acetonitrile, tetrahydrofuran, diethyl ether, methyl tent-butyl ether, an alcohol, a combination thereof, etc. The resulting solutions, suspensions, or colloids can be suitable for forming coatings on products.

In various example embodiments, coatings described herein can be at least about 40% water by mass or by volume. In some implementations, the solvent includes a combination of water and ethanol, and can optionally be at least about 40% water by volume. In some implementations, the solvent or solution/suspension/colloid can be about 40% to 100% water by mass or volume.

Coating agents formed from or containing a high percentage of long chain fatty acids and/or salts or esters thereof (e.g., having a carbon chain length of at least 14) have been found to be effective at forming protective coatings over a variety of substrates that can prevent water loss from and/or oxidation of the substrate. The addition of one or more medium chain fatty acids and/or salts or esters thereof (or other wetting agents) can further improve the performance of the coatings.

The sprayers 454A-B, as well as the rollers 458 that are underneath the sprayers, can be configured to control (e.g., reduce) the residence time that items 452 are subjected to output from the sprayers 454A-B and be coated with the sprayed liquid. In some implementations, the rollers 458 under the sprayers 454B can each be a first type of brush roller 459B configured to absorb liquid that is sprayed thereon by sprayer 454B and to subsequently brush it onto items that pass thereover. The rollers 458 under the sprayers 454A can be the same as those under the spray 454B, and/or can include a second type of brush roller 459A that is different from the first type of brush roller 459B and which can, for example, be configured to promote rotation of the items 452 as the items 452 pass underneath the sprayers 454A.

The output of sprayers 454A, 454B can be regulated based on the presence/absence of items 452, mass throughput of items 452 (e.g., instantaneous mass throughput, average mass throughput, etc.). In some methods of operation of the treatment apparatus 470, the sprayers 454B can spray liquid (e.g., continuously) while there are no items beneath sprayers 454B in order to keep the rollers thereunder saturated, and optionally do not spray liquid while there are items on the bed beneath. In other methods of operation, the sprayers 454B spray liquid continuously both while there are items on the bed beneath and when there are no items on the bed beneath. In some methods of operation, the sprayers 454A spray liquid while there are items on the bed beneath but not while there are no items beneath. In some methods of operation, the sprayers 454A spray liquid continuously both while there are items on the bed beneath and when there are no items on the bed beneath.

The rollers used in the systems described herein facilitates movement of the items 452 and/or application of an agent to the items 452. In some implementations, the portion of the application section of the system (e.g., the portion of the bed beneath the sprayers) closest to where items are loaded onto the bed contains straight polyether sulfone (PSE) and/or PSE/horsehair brushes, and the portion of the application system closest to where items are removed from the bed contains scalloped PSE and/or PSE/horsehair brushes. The straight brushes may be configured to arrange (e.g., align) items to assist in the translation and uniformity of items entering the system. In some embodiments, scalloped brushes cause increased contact of an agent (e.g., coating solution/suspension/emulsion) onto the arranged items, facilitating efficient application.

The liquid that is sprayed by the sprayers 454A-B can be prepared in one or more mixing tanks 482. Water and/or any other solvents can be supplied to the mixing tanks 482 from outside the industrial equipment 470. When water is supplied, water pre-treatment equipment may be included. The liquid in the tanks can be prepared by heating to a target temperature, adding a coating agent or other additive or solute, and pumping the undispersed mix through a controlled high shear device in a recirculation loop until the additive is well dispersed.

The prepared solution/suspension is delivered to the sprayers and sprayed onto underlying rollers and/or items on the bed beneath the sprayers. A liquid delivery system 484, which can be connected inline between the tanks 482 and the sprayers 454 (including 454A-B), can provide a controlled pressure/flowrate of liquid to the sprayers 454 so that the amount and distribution of liquid sprayed over the equipment and items to be treated can be precisely controlled. The flowrate of liquid that is emitted from the sprayers 454 can be controlled by an actuating valve in the spray nozzle, by the pump in the liquid delivery system, or other regulating device, for example. The value which the flowrate is set to can depend at least partially on the rotation rate of the rollers and/or on the translational rate of items on the bed (e.g., mass flow rate of items 452), and one or more other operational parameters described herein, for example. Use of brush rollers in one or more of the configurations previously described can allow for high material use efficiency and correspondingly low sprayer flowrates.

The physical length of the section of the bed over which sprayers are mounted is relatively short while facilitating selected coverage of the items by the sprayed liquid, and/or a relatively low residence time of the items beneath the sprayers. In some implementations, the length of the section of the bed over which the sprayers are mounted is less than about 10 feet, less than about 9 feet, less than about 8 feet, less than about 7 feet, less than about 6 feet, or less than about 5 feet. In some implementations, the total residence time of items underneath the sprayers is less than about 2 minutes, less than about 1 minute, less than about 30 seconds, less than about 15 seconds, less than about 5 seconds, or less.

The at least partially coated items 452 pass under a drying system 490, which include blower exhausts 460A-E (collectively 460) connected to respective blowers 464A-E (collectively 464) in a blower system 462. The drying system 490 can be used to implement the treatment apparatus 100 of FIGS. 1A-1B, for example.

The blower(s) 464 connected to the exhausts 460 can dispense air and/or other gasses (e.g., nitrogen, hydrogen, air, or combinations thereof) onto the items 452. In some implementations, the blowers 464 are equipped with heaters that heat the air and/or other gasses such that the exhaust is delivered from the blowers at a controlled temperature. Heated air/gas can cause the solvent to evaporate at a desired rate (e.g., more quickly) and in some cases may result in more uniform protective coatings having a desired thickness formed on the items 452 from coating agents in the liquid. In some implementations, the air/gas is dispensed from the blowers 464 at a temperature of between 30 ° C. and 110 ° C. In an example embodiment, the system includes 5 sets of blower exhausts. In various example embodiments, additional or fewer blower exhausts may be used to output exhaust at a desired rate, velocity, location, direction, etc., to facilitate controlled drying of items 452.

The exhaust from blowers 464 can be controlled to deliver air/gas within a selected relative humidity range. Exhaust of air/gas having a selected relative humidity can cause the solvent to evaporate at a desired rate (e.g., more quickly) and in some cases may facilitate formation of relatively uniform protective coatings having a desired thickness on the items 452. In various example embodiments, the relative humidity within the system may be controlled so that the relative humidity of the air/gas delivered from blowers 464 is about the same as the relative humidity at other locations within the system (e.g., at an upstream location of sprayers 454). In some embodiments, the relative humidity of the air/gas delivered from blowers 464 is less than that of an ambient relative humidity (e.g., surrounding the exterior of the system) and/or less than an average ambient humidity within the system (e.g., at an upstream location of sprayers 454).

In some embodiments, the blowers are centrifugal blowers capable of providing high velocity (and optionally heated, humidity controlled, etc.) air/gas to dry the items (e.g., through convection). For example, the velocity of air/gas dispensed from the blowers can be 50-110 ft/min. The system may include air plenums configured to create a pressure drop across the width of the bed in order to promote balanced airflow to all items passing beneath the drying system and to increase the amount of fluid to evaporate from the items before the items reach the end of the bed. The relative humidity between the blowers and the underlying bed while air/gas is dispensed from the blowers can be below 50%. Substantially complete drying of the items by the drying system can be achieved in times of about 300 seconds or less.

In the drying section of the bed (e.g., the section beneath the blowers 460), one or more of quick dry and nylon, or full nylon, rollers can be utilized to reduce the loss of product (e.g., coating agent) from the surface of the items being coated while drying/depositing product onto the item surface. The drying/evaporation of water occurs simultaneously with the formation of the coating film without removal of the product from the item surface. Such techniques can facilitate a controlled drying process that results in a predefined coating thickness, coating mosaicity, etc., on the item surface that is relatively consistent between items. Alternatively, or additionally, the combination of nylon and quick dry rollers can facilitate consistent and high mass flow of items through the drying section. Various combinations of nylon and rubber rollers can maintain and protect the applied coatings as the items move through the system. In some implementations, the system includes a brush bed separate from (e.g., upstream) of the drying system, and the drying system includes a rolling, translating conveyor.

The length of the section of the bed over which the blower exhausts are mounted can be less than about 12 feet. In various example embodiments, the length of the section of the bed over which the blower exhausts are mounted can be between 2 feet and 24 feet, 4 feet and 16 feet, or 6 feet and 12 feet. In some embodiments, such blower exhaust lengths can facilitate an entire length (e.g., including application and drying sections), that are less than 48 feet, less than 36 feet, less than 24 feet, or less than 20 feet, thereby facilitating a compact design while promoting complete coating and drying of the items placed on the bed. The roller diameter can vary depending on items being treated. For example, the roller diameter can be in a range of about 3 cm to 30 cm.

The treatment apparatus 470 can be at least partially controlled and/or automated via a computer and associated software. For example, automated control can allow the system 470 to generate continuous flow of product (e.g., solutions, suspensions, or emulsions used to treat items) through automatic switches to the sprayers, and can control operation cycles of the mixing system between formulating (e.g., preparing the product) and delivery of the product to the sprayers for application to items. In some embodiments, treatment apparatus 470 can be controlled by a treatment parameter system (e.g., treatment parameter system 204), either in real time via one or more feedback loops or using parameters previously generated by the treatment parameter system.

Referring to FIGS. 5A-B, an example surface drying model 500 is shown. The drying model may be used to describe one or more layers (FIG. 5A) present during drying an item 502 (e.g., avocado). For example, the layers can include an item surface 504, an at least partially liquid coating layer 506, a boundary layer 508, and a convective air stream 510. The convective air stream 510 can be generated to act on the coating layer 506/boundary layer 508.

As described herein, the coating layer 506 can be formed by a solute composition and used to prevent food spoilage due to, for instance, moisture loss, oxidation, or infection by a foreign pathogen. The coating layer 506 can include the coating agent. Examples of the coating agent include monoacylglycerides, fatty acids, esters (e.g., fatty acid esters), amides, amines, thiols, carboxylic acids, ethers, aliphatic waxes, alcohols, fatty acid salts, organic salts, inorganic salts, or combinations thereof.

The boundary layer 508 may be formed proximate the at least partially liquid coating layer 506 as the solvent is diffused from the coating layer 506. The boundary layer 508 may have a relatively high concentration of solvent as the solvent diffuses from the coating layer 506 and is carried away in the convective air stream 510.

As described herein, the solvent can be water. Alternatively, or in addition, the solvent can be an alcohol (e.g., ethanol, methanol, isopropanol, or combinations thereof), acetone, ethyl acetate, tetrahydrofuran, or combinations thereof, for example.

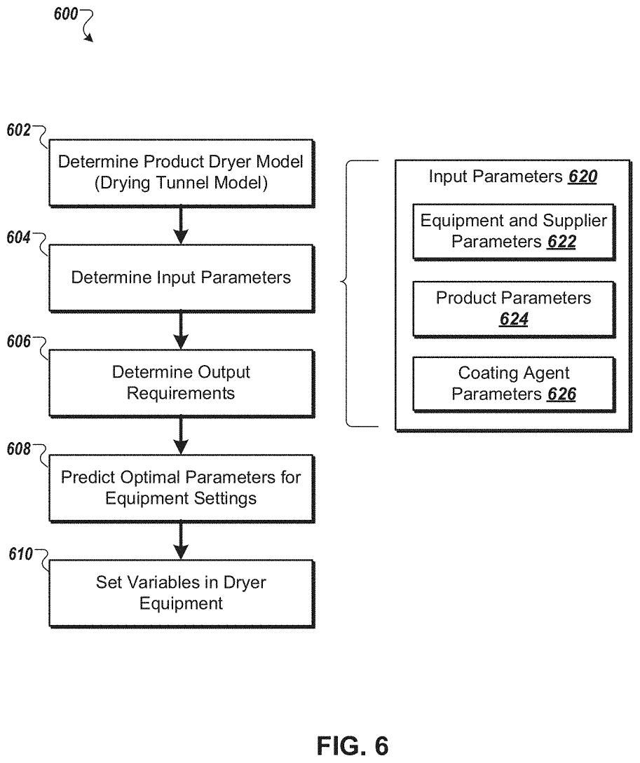

Water content (percentage) of the coating product may affect other parameters (e.g., input parameters 620 (FIG. 6) and the desired result (e.g., dryness, coating performance, etc.)). By way of example, if the coating agent has a high-water content, a relatively high temperature of air, a relatively long curing time, and/or a relatively high air turbulence may be used to dry water from the coating product on the product. In an example embodiment, the air temperature, curing time, and/or air turbulence is below a threshold value to limit or prevent removal (“knock-off”) of the coating product from the product.

Referring now to FIG. 5B, the surface drying model 500 can be characterized (Block 522) by determining (e.g., calculating) a diffusion at the item surface 504 (Block 524) and determining (e.g., calculating) a heat transfer (Block 526). The surface drying model 500 can be applied to a product dryer model (Block 528), described herein, for example.

In some implementations, the diffusion of liquid molecules (e.g., water) on the item surface 504 can be characterized using Fick's laws of diffusion that include Fick's first and second laws. Fick's laws of diffusion can be used to solve for the diffusion coefficient (D). Fick's first law can be used to derive his second law, which in turn can be identical to the diffusion equation.

$$\begin{matrix}J = - D \frac{dc}{dx} & Equation 1 \\ \frac{\partial c}{\partial t} = D \frac{{d}^{2} c}{{dx}^{2}} & Equation 2\end{matrix}$$

where J is the diffusion flux, which provides the amount of substance per unit area per unit time. J measures the amount of substance that will flow through a unit area during a unit time interval;

D is the diffusion coefficient or diffusivity (area per unit time);

c (for ideal mixtures) is the concentration (amount of substance per unit volume);

x is position (length); and

t is time.

Fick's first law (Equation 1) can be used to characterize how diffusion across the boundary layer is driven by the concentration gradient, and Fick's second law (Equation 2) can be used to characterize how diffusion causes the concentration to change with respect to time. Solving at a pseudo steady state is facilitated using boundary condition Equations 3 and 4:

$$\begin{matrix}0 = D \frac{{d}^{2} c}{{dx}^{2}} & Equation 3 \\ c ( x ) = {c}_{1} + {c}_{2} x & Equation 4\end{matrix}$$

Thermodynamic equilibrium exists at the boundary layer. The fugacity is equivalent:

μ^{L}=μ^{BL}(0). Equation 5

Ideal gas simplifying assumption, the concentration at the interface is given by the vapor pressure (P^{sat}):

$$c ( 0 ) = \frac{{P}^{sat} ( {T}^{L} )}{RT} \qquad Equation 6$$

Using the concentration profile (Equation 6), the diffusion flux (J) can be calculated:

$$J = - \frac{D}{t} ( {c}_{∞} - \frac{{P}^{sat} ( {T}^{L} )}{RT} ) \qquad Equation 7$$

Where the thickness of the boundary layer cannot be measured,

$$\frac{D}{t}$$

can be fitted as a function of dimensionless quantities Reynolds number and Schmidt number:

$$\frac{{k}_{m} l}{D} = f ( Re , Sc ) \qquad Equation 8$$

where kₘ is a mass transfer coefficient; and (Re,c) is a semi empirical function fit for different geometries. As described herein, this may be fitted from experimental data in some implementations.

In some implementations, the heat transfer (heat flux) to the surface is driven by a temperature gradient:

Q=h(T_{∞}−T^{L}): Equation 9

where Q is the heat rate per unit area, and h is the heat transfer coefficient.

The heat transfer coefficient is fit as a function of the Rayleigh number and Prandtl number:

$$\frac{hl}{k} = f ( Ra , Pr ) \qquad Equation 10$$

where h is a heat transfer coefficient, and f is a semi empirical function fit for different system geometries. In some implementations, h, kₘ are scale-independent parameters.

When applying the surface drying model to a drying tunnel model, a convective heat transfer to the liquid (e.g., the coating layer 506 in a liquid phase (“L”)) from the convective air stream 510 (in a gas phase (“G”) can be represented by:

Q_{f}(z)=h_{f}A_{f}(T_{g}−T_{L}(z)): Equation 11

where Q_{f} is heat flux into fruit/liquid barrier, h_{f} is the heat transfer coefficient of fluid, A_{f} is a surface area of coated product, T_{g} is the temperature of the gas, and T_{L} is the temperature of the liquid.

In the convective heat transfer, the liquid temperature can be assumed to be equivalent to incoming item temperature due to its small layer.

A convective mass transfer of the liquid away from the item surface 504 is represented by:

\dot{m}ₑ(z)=kₘA_{f}ρ_{g}(H^{sat}(T_{L}(z),c(z))−RH*H^{sat}(T_{g})): Equation 12

where \dot{m}ₑ is the evaporation-based mass transfer rate, kₘ is a mass transfer coefficient, A_{f} is a surface area of coated product, P_{g} is the gas density, H^{sat} is the saturation vapor pressure, T_{L} is the temperature of the liquid, T_{g} is the temperature of the gas, and RH is the relative humidity. Evaporative mass transfer is a function of the gradient of the water concentration between the gas and the liquid.

The convective mass transfer may be associated with a concentration gradient based on a vapor pressure of the solution and a humidity profile in the tunnel.

Evaporative cooling of the item can be represented by:

Qₑ(z)=\dot{m}ₑ(z)λ: Equation 13

where Qₑ is the evaporative heat transfer and λ is the heat of vaporization.

Conduction of heat into the item can be represented by:

Q_{fs}=hₐA_{f}(T_{L}(z)−T_{f}): Equation 14

where Q_{fs} is the heat flux into the coated product surface, hₐ is the heat transfer coefficient of the coated product, A_{f} is a surface area of coated product, T_{L} is the temperature of the liquid, and T_{f} is the temperature of the coated product. This characterizes the amount of energy transferred into the coated product.

A removal (“knock off”) of the coating layer 506 can be represented by:

\dot{m}_{KO}=KO*\dot{m}_{L}ⁱⁿ: Equation 15

where \dot{m}_{KO} is the mass transfer rate related to knock off, KO is the knock off percentage of liquid on the coated product, and \dot{m}_{L}ⁱⁿ is the mass transfer rate of liquid going onto the coated product. Equation 15 accounts for the liquid that is removed through physical transference, dripped off, etc. (e.g., rather than as a result of evaporation).

FIG. 5C illustrates example air circulation in and around a drying tunnel 560. The drying tunnel 560 can include one or more features of any of the drying tunnels described herein, such as the treatment apparatus 100 or the drying system 490. Items 502 are transported by a conveyor system 570. The items 520 can be coated with a coating mixture that is spayed at a coating system 550. The coating system 550 can be implemented by any of the coating systems described herein, such as the coating system 480. The coated items are then introduced into the drying tunnel 560 where a drying air is supplied, circulated, and discharged.

In some implementations, drying air may be supplied into the drying tunnel 560 from an active source (e.g., the blower system 462) and/or a passive source (e.g., ambient air). The air supplied into the drying tunnel may be circulated within the drying tunnel 560, facilitating removal of the solvent (e.g., water) from the surface of the item 502 (e.g., through the heat transfer and diffusion mechanisms discussed above).

In some implementations, a water mass balance at the drying tunnel 560 can be represented by:

$${ρ}_{g} {VH}^{sat} ( {T}_{g} ) \frac{dRH}{dt} = {ρ}_{g} {F}_{v} {H}^{sat} ( {T}_{in} ) {RH}_{in} - {ρ}_{g} {F}_{v} {H}^{sat} ( {T}_{g} ) RH + \int {\dot{m}}_{e} ( z ) dz \qquad Equation 16$$

where Fᵥ is the fresh air intake flowrate and V is the air volume of the tunnel.

Further, a heat balance at the drying tunnel 560 can be represented by:

$$\begin{matrix}{ρ}_{g} {Vc}_{pg} \frac{{dT}_{g}}{dt} = - {ρ}_{g} {F}_{v} {c}_{pg} ( {T}_{g} - {T}_{ref} ) + {Q}_{HE} + \int ( - {Q}_{f} ( z ) + {Q}_{e} ( z ) ) dz & Equation 17 \\ {Q}_{HE} = {ρ}_{g} {F}_{v} {c}_{p , in} ( {T}_{HE} - {T}_{in} ) & Equation 18\end{matrix}$$

where ρ_{g} is the vapor phase density, c_{pg} is the heat capacity of the gas, Q_{HE} is the heat flux through the heat exchanger, T_{HE} is the temperature of the heat exchanger, Tᵢₙ is the temperature of incoming fresh air, and C_{p,in} is the heat capacity incoming fresh air.

FIG. 6 is a flowchart of an example process 600 for controlling and operating a drying apparatus to achieve desired coating characteristics, energy usage, physical footprint, etc, and/or modifying an existing drying apparatus based on one or more determined variables. The process 600 can be used to implement at least part of the treatment parameter system 104 in FIG. 1B.

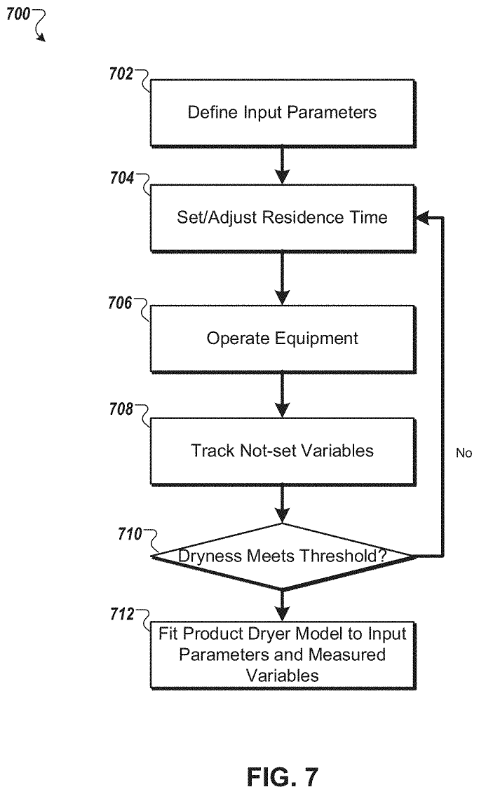

In some implementations, the process 600 includes determining a product dryer model (602). The product dryer model may represent operation and performance for one or more drying apparatuses. The product dryer model can be used to determine optimal variables for customizing a particular drying apparatus to output a desired drying performance (e.g., dryness) for an incoming item. The product dryer model can be used to select or design a new drying apparatus to generate a desired drying performance for a particular item (e.g., instead of customizing an existing drying apparatus). An example process for building the product dryer model is described with reference to FIG. 7.

The process 600 includes determining input parameters (604). The input parameters 620 can be defined for particular drying equipment, items, coating agents, or other relevant conditions associated with the drying operation. For example, the input parameters 620 can include equipment and supplier parameters 622, product parameters 624, and coating agent parameters 626.

The equipment and supplier parameters 622 include parameters specific to the drying apparatus and/or supplier requirements. In various example embodiments, equipment and supplier parameters 622 include one or more of mass throughput (e.g., of product items to be coated), ambient temperature, ambient humidity, post heat exchanger temperature, post heat exchanger humidity, product path air velocity, conveyor length, conveyor width, and heated chamber height.

For example, mass throughput of the product to be coated, and adherence rate onto the product to be coated, can be used to define the incoming liquid mass rate used as the initial conditions in Equations 16 and 17. The geometry of the system (length, width, height) can be used to characterize the volume of air in the system (e.g., V in Equations 16 and 17). The length and mass throughput yields the residence time within the system, or the length and time intervals over which Equations 16 and 17 can be solved. The product path air velocity, the product geometries, and product densities and viscosities can define the heat and mass transfer coefficients used in, for example, Equations 12 and 14.

The product parameters 624 may include parameters specific to the items being treated. In various example embodiments, the product parameters 624 can include one or more of product geometry, density, temperature, thermal conductivity, skin thickness, water content, composition, and surface area.

The product geometry and density may affect uniformness and effectiveness of coating application and drying. For example, a smooth contour of product can facilitate even application of the coating agent on the surface of the product, and efficient drying of water content from the coated product. Further, relatively cold product (e.g., items delivered from a cold storage) may benefit from air having a relatively high temperature and/or a relatively high velocity to evaporate water content from the coated product. Products with a relatively high thermal conductivity may benefit from drying air having a relatively lower temperature to reduce effect of the drying air on the product temperature during the drying process. Products with a relatively thick skin may tolerate a relatively high temperature of air. Products with a relatively large surface area may benefit from use of relatively high air temperature, a relatively fast air velocity, and/or longer residence time through the drying tunnel.

The coating agent parameters 626 include parameters specific to the coating agent that is coated on the surface of the item being treated. In various example embodiments, the coating agent parameters 626 can include one or more of an adherence rate, dynamic viscosity, mass diffusivity, specific heat capacity, latent heat of vaporization, thermal conductivity, density, heat transfer coefficient, and mass transfer coefficient.

Referring still to FIG. 6, the process 600 can include determining one or more output requirements. For example, the output requirements may include a desired drying performance. The drying performance can be characterized by one or more parameters, such as one or more parameters that indicate a dryness level, an amount of moisture or solvent removed from the item surface, coating agent thickness, opacity, gloss, etc.

In some implementations, the drying performance (as well as a coating performance) can be represented by mass loss. The mass loss indicates a mass of water that is produced during the drying process (e.g., evaporated from the liquid coating on the item of the surface). Alternatively, or additionally, dryness can be characterized through use of water soluble compounds which emit differing fluorescence when in aqueous solution compared to when dried, and/or infrared (IR) moisture detection.

The process 600 can include predicting optimal parameters for equipment settings (608). The optimal parameters can be determined using the product dryer model with the determined input parameters and output requirements. The determined optimal parameters may be associated with one or more settings for the drying apparatus, which may lead to the desired drying performance of the incoming items.

The process 600 can include operating the equipment (e.g., the drying apparatus) based on the determined optimal parameters (610). For example, the settings of the drying apparatus can be adjusted and customized for the particular items to achieve the desired dryness and/or other requirements.

FIG. 7 is a flowchart of an example process 700 for fitting a product dryer model. The process 700 can be used to construct one or more aspects of the product dryer model that is described in FIG. 6, for example. The process 700 can include defining at least one of the input parameters 620 (702). As described herein, the input parameters 620 can include the equipment and supplier parameters 622, the product parameters 624, and the coating agent parameters 626.

The process 700 can include setting a residence time of items in the drying apparatus (704), and operating the drying apparatus to perform a drying process of the items (706). The drying apparatus is operated according to the defined input parameters and the residence time. The process 700 can include tracking variables that are not specifically set (708). Such variables can include the output requirements, such as a dryness. The dryness of the items can be determined in various methods, such as mass loss rate, evaporation rate, change in flourescence, and/or infrared moisture detection techniques.

The process 700 can include determining whether a dryness of the items meets a threshold (710). The threshold can represent a desired value or range of dryness values, in some implementations. Alternatively, or additionally, the threshold can represent combined desired values or ranges of multiple drying requirements such as dryness, throughput, residence time, coating thickness, coating mosaicity, amount of solvent, concentration of coating solution, evaporation rate of solvent, etc. If the dryness meets the threshold, the process 700 moves on to operation 712 in which a product dryer model is fitted to the input parameters and the tracked variables (outputs). If the dryness does not meet the threshold, the process 700 returns to the operation 704 in which the residence time is adjusted (e.g., reduced or increased), and the subsequent operations are performed as described above. As described in FIG. 6, the product dryer model is used to predict desired parameters for the drying apparatus to generate a desired output (e.g., dryness and/or other requirements) for particular items.

In some implementations, with the drying apparatus known, and the set of input parameters and output measurements being defined, the heat and mass transfer coefficients can be fit into the product dryer model. The heat and mass transfer coefficients can be balanced with, for example, product specific values (e.g., the product parameters 624) and/or adherence rate estimates (e.g., the coating agent parameters 628). Each model fit may be specific to a drying apparatus, a product type, a concentration, a flow rate, and/or other relevant factors. In some implementations, however, each model fit can be extended to other drying apparatuses, product types, concentrations, flow rates, and/or other relevant factors, by adjusting according to one or more trends.

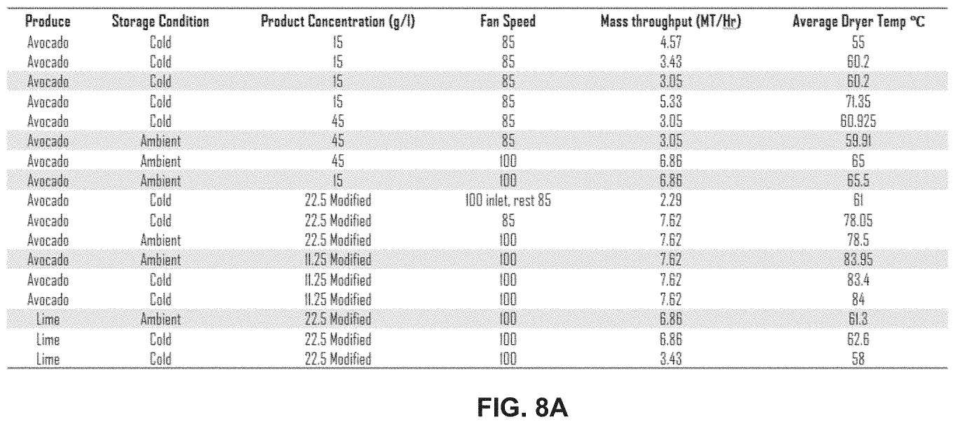

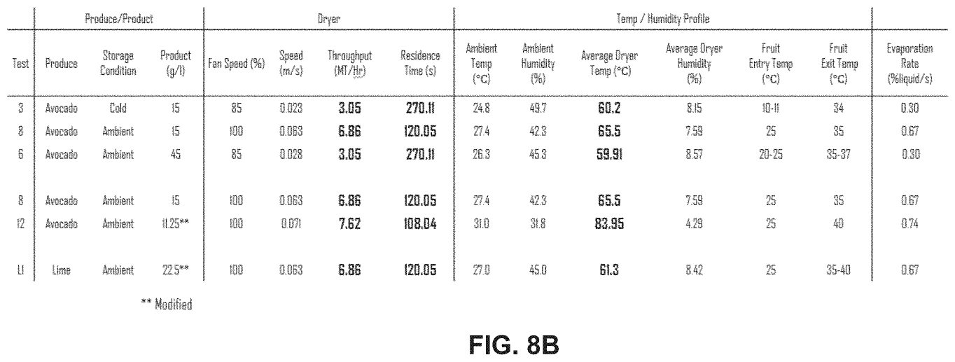

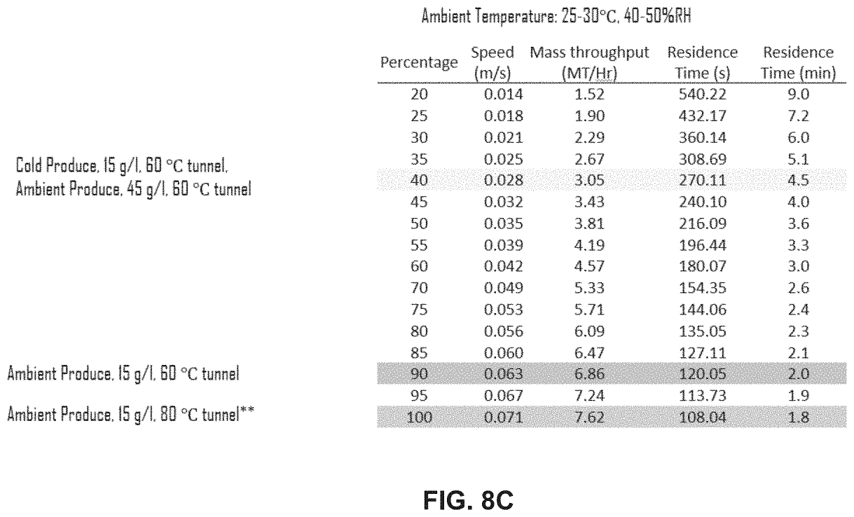

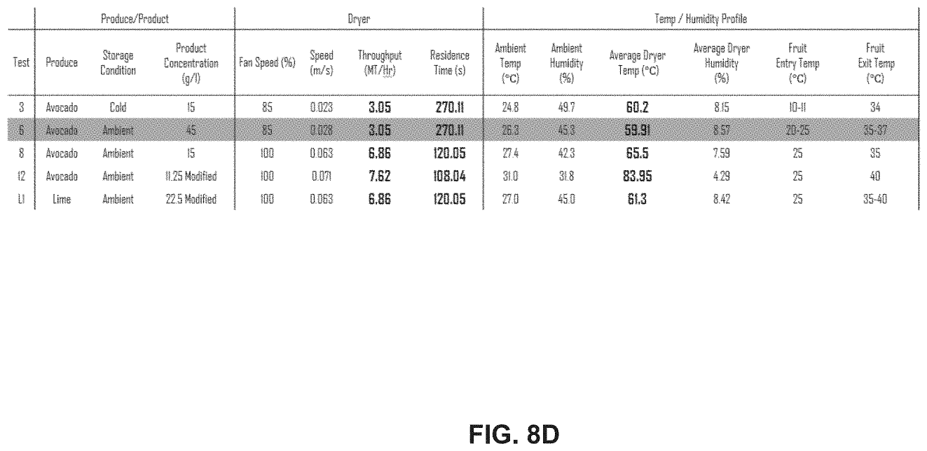

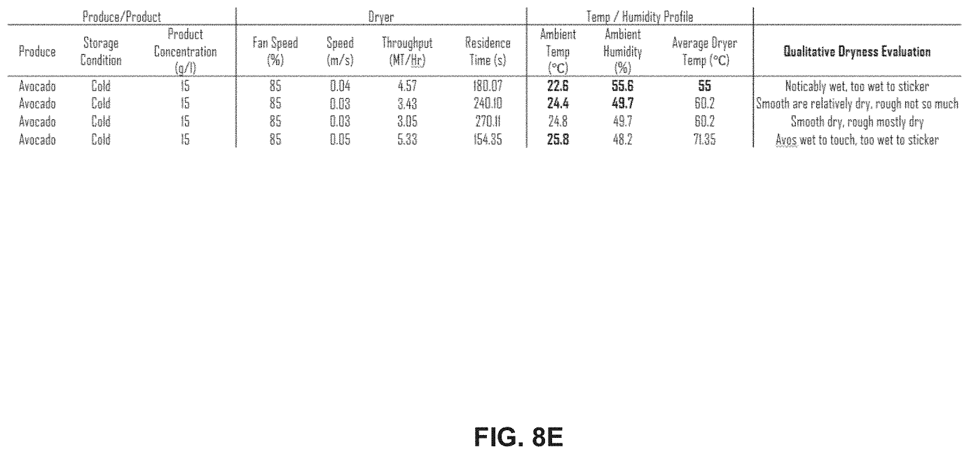

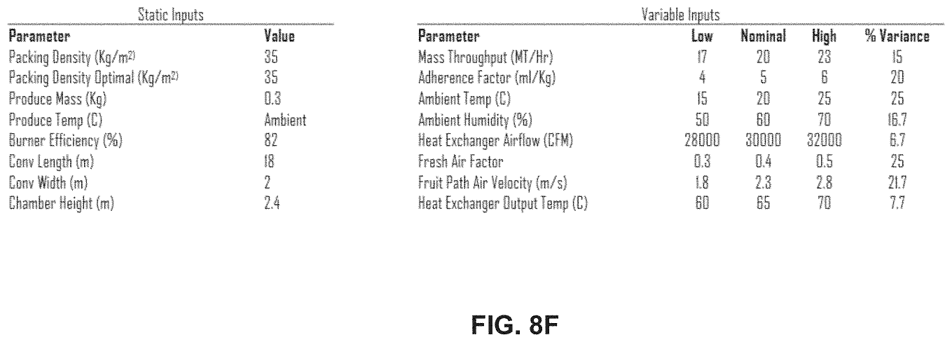

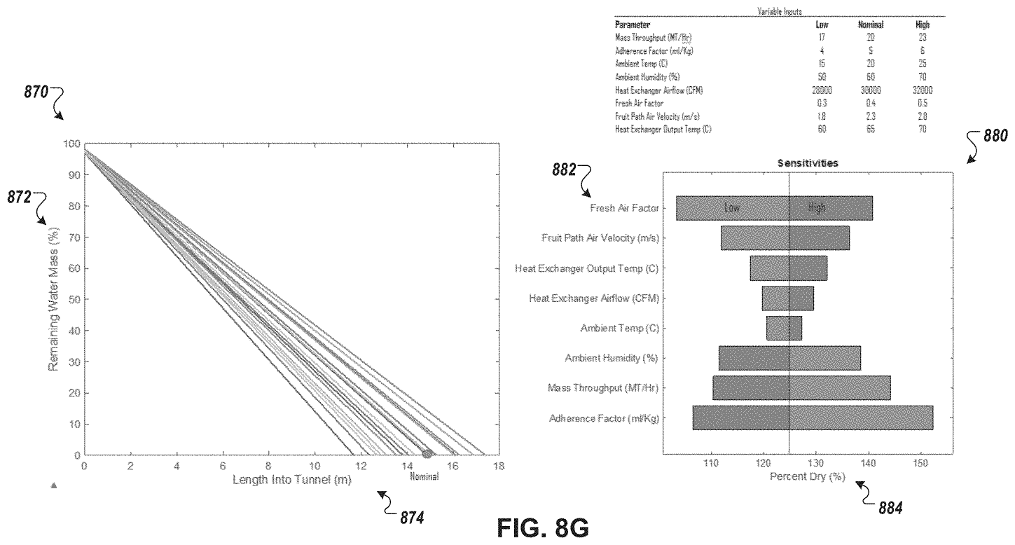

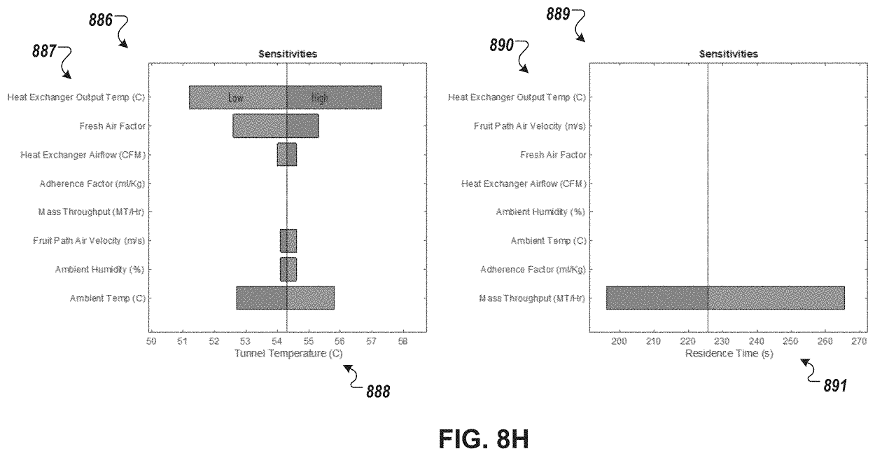

Referring to FIG. 8A-I, an example embodiment of process 700. For example, referring to FIG. 8A, different sample items (avocado and lime) may be treated (coated and dried) under various conditions. The sample items may enter the drying tunnel at different temperatures (cold vs. ambient), and at a different product concentration (e.g., different mass flow rate). The drying tunnel may be configured to provide different combinations of fan speeds, mass throughputs, and average dryer temperatures. Referring to FIG. 8B, various parameters may be measured, such as a dryer speed, residence time, ambient temperature, ambient humidity, an average dryer humidity, an item entry temperature, an item exit temperature, and an evaporation rate. Referring to FIG. 8C, given the data collected, several operational parameters can be estimated. For example, the parameters that were set and measured can be extrapolated to estimate such parameters under different conditions. Referring to FIG. 8D, given the data that were collected and estimated, a product dryer model can be fitted. Referring to FIG. 8E, additional results may be considered to fit the product model.

Referring to FIG. 8F, the input parameters can be set based on the product dryer model. The input parameters may include static input parameters and variable input parameters. In this example, the static input parameters include a packing density of product, product mass, product temperature, a burner efficiency, conveyor length and width, and a chamber height. The variable input parameters may include mass throughput, adherence factor, ambient temperature, ambient humidity, heat exchange airflow, fresh air factor, item path air velocity, and heat exchange output temperature. The variable input parameters can be set as a range (Low, Normal, and High with a percentage variance).

Referring to FIG. 8G, given the input parameters that were set, the drying result may be evaluated. The drying result may be characterized as a remaining water mass 872 over a length into the drying tunnel 874 as shown in a graph 870. Further, as shown in a diagram 880, a sensitivity 882 of each of the input parameters (e.g., fresh air factor, product path air velocity, heat exchange output temperature, heat exchanger airflow, ambient temperature, ambient humidity, mass throughput, and adherence factor) was evaluated against a dryness percentage 884. Referring to FIG. 8H, as shown in a diagram 886, a sensitivity 887 of each of the input parameters (e.g., fresh air factor, item path air velocity, heat exchange output temperature, heat exchanger airflow, ambient temperature, ambient humidity, mass throughput, and adherence factor) was evaluated against a tunnel temperature 888. As shown in a diagram 889, a sensitivity 890 of each of the input parameters (e.g., fresh air factor, item path air velocity, heat exchange output temperature, heat exchanger airflow, ambient temperature, ambient humidity, mass throughput, and adherence factor) was evaluated against a residence time 891. Referring to FIG. 81, as shown in a diagram 892, a sensitivity 893 of each of the input parameters (e.g., fresh air factor, item path air velocity, heat exchange output temperature, heat exchanger airflow, ambient temperature, ambient humidity, mass throughput, and adherence factor) was evaluated against a burner energy 894. As shown in a diagram 895, a sensitivity 896 of each of the input parameters (e.g., fresh air factor, item path air velocity, heat exchange output temperature, heat exchanger airflow, ambient temperature, ambient humidity, mass throughput, and adherence factor) was evaluated against a relative humidity 897.

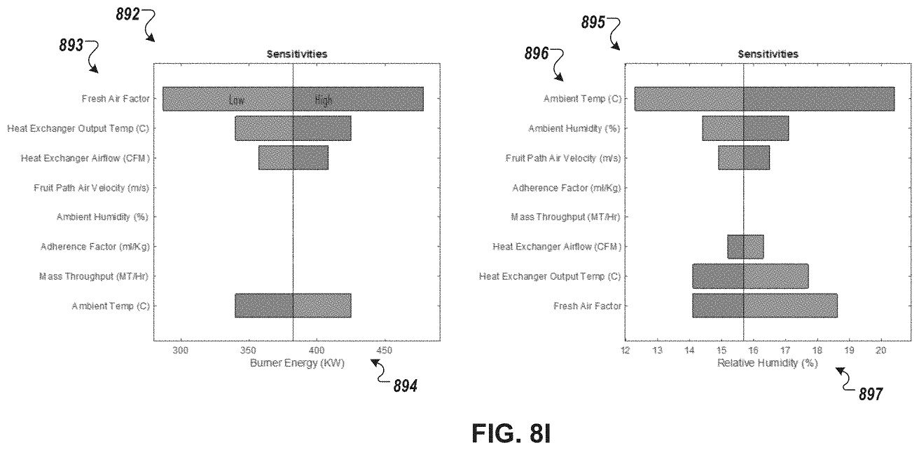

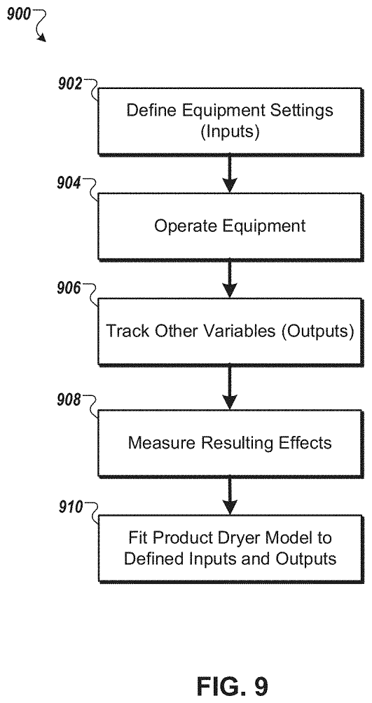

FIG. 9 is a flowchart of another example process 900 for fitting a product dryer model. The process 900 can be used to build the product dryer model that is described in FIG. 6. The process 900 can include defining one or more settings of a drying apparatus (902). Example settings of the drying apparatus, which can be defined, include at least one of the input parameters 620. The process 900 can then include operating the drying apparatus to perform a drying process of items (904). The drying apparatus is operated according to the defined setting. The process 900 can include tracking variables that are not specifically set (906). Such variables can include the output requirements, such as a dryness. In addition, or alternatively, the variables being monitored can include one or more of the input parameters 620 that are not specifically set to operate the drying apparatus.

The process 900 can include measuring resulting effects on one or more variables associated with the operation of the drying apparatus. In some implementations, the variables being measured can include item speeds, airflow dynamics, and/or temperature profiles. The item speeds can represent the throughput of the items at the drying apparatus. The airflow dynamics include flow rates, directions, and other properties of air that are monitored at one or more locations in and around the drying apparatus. In some implementations, the airflow dynamics can also include temporal information that indicate variations of the airflow rates, directions, and other properties over time. The temperature profiles include temperatures of air at one or more locations in and around the drying apparatus. In some implementations, the temperature profiles can include temporal information that indicate variations of air temperatures over time.

The process 900 can include fitting a product dryer model 910 to the defined inputs (e.g., the defined settings of drying apparatus at operation 902) and outputs (e.g., tracked variables at operations 906 and/or 908). As described in FIG. 6, the product dryer model is used to predict optimal settings for the drying apparatus to generate a desired output (e.g., dryness and/or other requirements) for particular items.

Referring to FIG. 10A-F, an example sequence is described using the process 900.

Referring to FIG. 10A, an example airflow 1020 is illustrated relative to a product flow 1022 at a drying tunnel 1002. One or more heater control sensor(s) 1024, air velocity sensor(s) 1026, temperature and humidity sensor(s) 1028, and ambient air sensor(s) 1030, may be positioned throughout the dryer tunnel to facilitate monitoring and control to of the drying tunnel 1002 and facilitate operation within desired process parameters. In some examples the sensors 1024, 1026, 1028, and/or 1030 may be used to characterize operational parameters of the drying tunnel 1002. Alternatively, or additionally, sensors 1024, 1026, 1028, and/or 1030 may be included in a feedback control loop to facilitate control of the drying tunnel 1002 (e.g., in real-time during operation of drying tunnel 1002).

Referring to FIG. 10B, a geometry of a dryer tunnel 1002 and an example product packing density are shown. Graphs 1010 and 1012 (FIG. 10C) show relationships between residence time of the product in the drying tunnel, and mass throughput of the product. Residence time generally decreases as conveyor speed/mass throughput increases. One or more other parameters may be adjusted to promote adequate drying as residence time decreases and/or mass throughput increases.

Referring now to FIG. 10D, in an example embodiment, the air velocity at various locations can be controlled to facilitate drying. Graph 1040 shows an example relationship between the airflow and the fan speed at different locations (e.g., burner chamber exit, burner chamber inlet, and air exhaust). Referring to FIG. 10E, an item path air velocity is shown. The air velocity that the item is subjected to affects the drying process and formation of the dried coating on the item. Graph 1050 shows an example relationship between an air velocity at the item path and a fan speed. The air velocity can be evaluated in a direction parallel to the fan body, and a direction perpendicular to the item path.

Referring to FIG. 10F, fit values with respect to the coating product may be determined. For example, data determined using the above process can be combined with system inputs (e.g., including date described above with reference to FIGS. 8A-C) to generate a model fit (e.g., such as that described above with reference to FIGS. 8D-E). Given the type of coating product, several parameters can be determined, such as adherence rate, dynamic viscosity, mass diffusivity, specific heat capacity, latent heat of vaporization, thermal conductivity, density, heat transfer coefficient, and mass transfer coefficient. In an example embodiment, one or more values of a coating composition having a relatively high-water content can be approximated based on the values of water. For example, one or more of dynamic viscosity, mass diffusivity, specific heat capacity, latent heat of vaporization, thermal conductivity, and density may be approximated by using the values of water. Based on these characteristics, an adherence rate can be predicted for one or more items. Graph 1060 shows an example relationship between the adherence rate and the application rate with respect to different items (e.g., avocado, oranges, and apples).

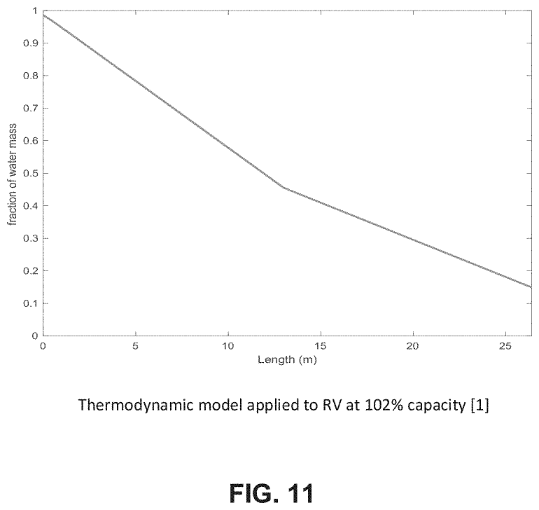

Referring to FIGS. 11-17, an example embodiment of characterizing and operating a treatment system (e.g., configuring a new system, modifying pre-existing treatment system, etc.) is shown. In an example embodiment, the treatment system is customized/operated to dry a particular product under predetermined conditions and requirements, such as at a predetermined mass throughput (e.g., 36 MT/hr), in a predetermined dryer length (e.g., 13 meters), at a predetermined linear speed (e.g., 0.25 m/s), and during a predetermined residence time (e.g., 52.8 seconds).

In some implementations, a treatment system can include a conveyor bed and a drying tunnel. Temperature and relative humidity may be measured at one or more locations of the system, including at the front of the drying tunnel (between roller layers), and/or at a distance (e.g., 4 meters) from the front of the drying tunnel (under circulation fans). Air velocities may be measured at one or more locations of the system, such as at a distance (e.g., 4 meters) from the front of a first pass drying line, at the center of the first pass drying line, and at the center of a second pass drying line.

In an example embodiment, one or more tests runs may be conducted, including a qualitative dryness assessment, using no coating, water only, a water-based coating composition, and/or one or more other coating treatments.

In an example embodiment one or more, functional conditions may be considered for several system attributes. In various embodiments, the functional conditions may vary based on application performance objections, average environmental considerations, etc. For example, the system may be configured to provide a predetermined evaporation rate, such as capability of evaporating water at a rate of 350 L/hr. This may be an amount of water on items (e.g., avocados) as the items pass through the dryer after application of coating product. In an example embodiment, such a rate may be sufficient based on a coating application rate of 15 Liters of coating product per mT of items (e.g., avocados), with a throughput rate 42 mT/hr. In some embodiments, only a portion of the liquid applied on the brush bed will adhere to the item entering the drying tunnel and need to be subsequently dried from the surface of the item. The system may have one or more physical drying mechanism conditions, such as a drying tunnel minimum length (e.g., 13.2 m), a one-layer, two-layer, or multi-layer design, a predetermined number of drying fans and capacity (e.g., 26 fans evenly distributed across the width and length of the drying tunnel). The system may have one or more air heating requirements, such as one or more burners having a predetermined burner output (e.g., 400,000 BTU/hr. In some embodiments, the burners may be evenly distributed across the length of the drying tunnel and centered about the width of the drying tunnel. In some embodiments, the system may include hot air leakage prevention and thermal management systems to enhance thermal efficiency and reduce leakage of heat into the production environment. In some embodiments, air recirculation mechanisms may be provided to facilitate evaporation at a predetermined rate. For example, burners may pull return air from the bottom of the dryer to promote thermal efficiency and better temperature distribution. In some embodiments, the internal electrical systems have an IP rating of IP65 or higher.

FIG. 11 illustrates a thermodynamic model applicable to the example system, demonstrating an expected dryness level (e.g., such as an expected dryness level of about 85% dry after 2 passes). The expected dryness level may be characterized based on a fraction of water mass remaining on the surface of the coated product. The fraction of water mass remaining decreases in relation to a length through the drying tunnel.

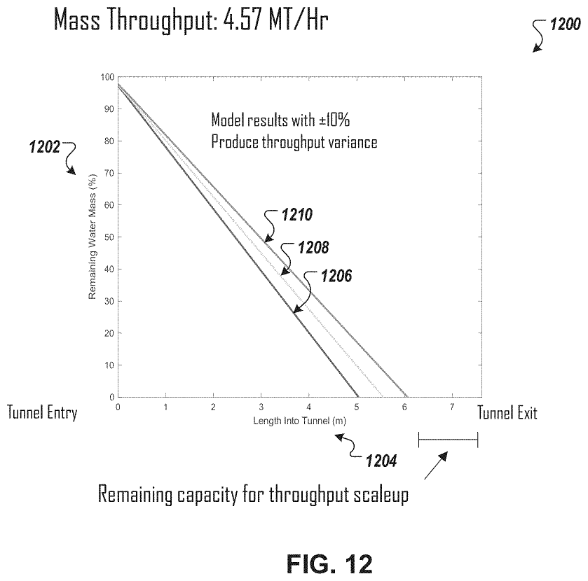

Referring now to FIG. 12, the remaining water mass percentage on the items in the drying tunnel can be predicted based on a length into the drying tunnel. In an example embodiment, a drying tunnel can be configured to provide a linear relationship between the remaining water mass percentage (1202) and the location of product at the tunnel (1204). The remaining water mass may decrease as the water content is dried from the product while the product is transported along the tunnel. Different throughputs of product (1206, 1208, 1210) may result in different evaporation rates. For example, a larger throughput of product result in a longer length of the tunnel to evaporate the water mass from the coated item to a predetermined remaining water mass value. A first throughput 1210is larger than a second or third throughput 1206, 1208 and requires a longer length of the tunnel to remove water content from the coated item, as compared to second and third throughputs 1206, 1208, assuming that other parameters remain constant. Similarly, the second throughput 1208 is larger than the third throughput 1206 and requires longer length of the tunnel to remove water content from the coated item, assuming that other parameters remain constant.

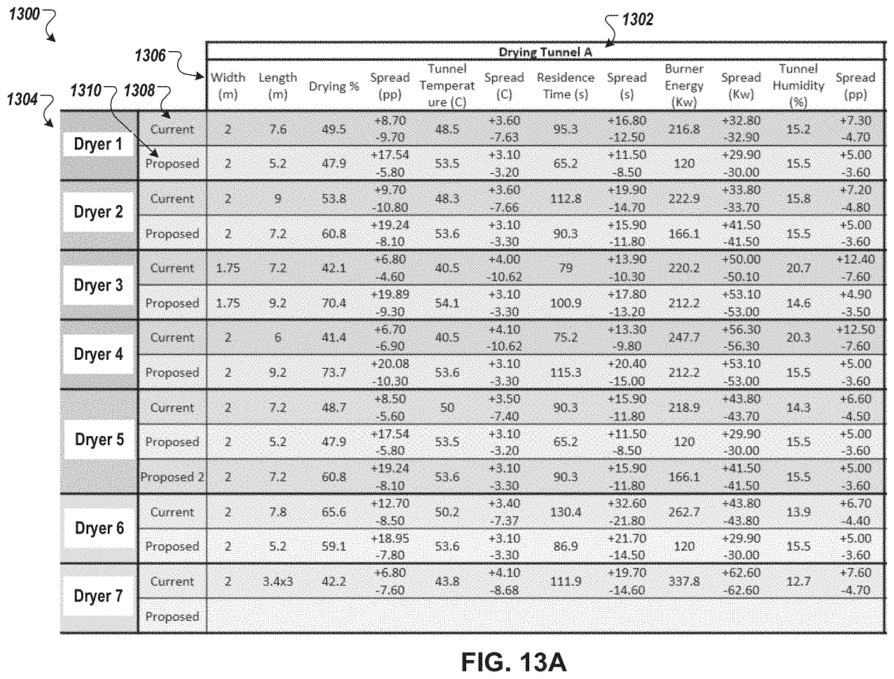

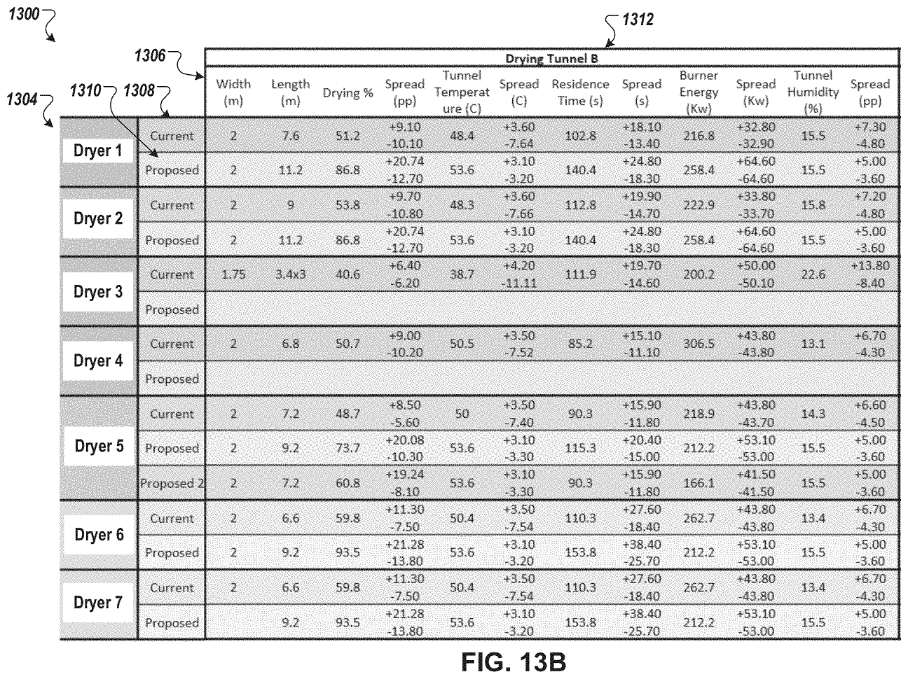

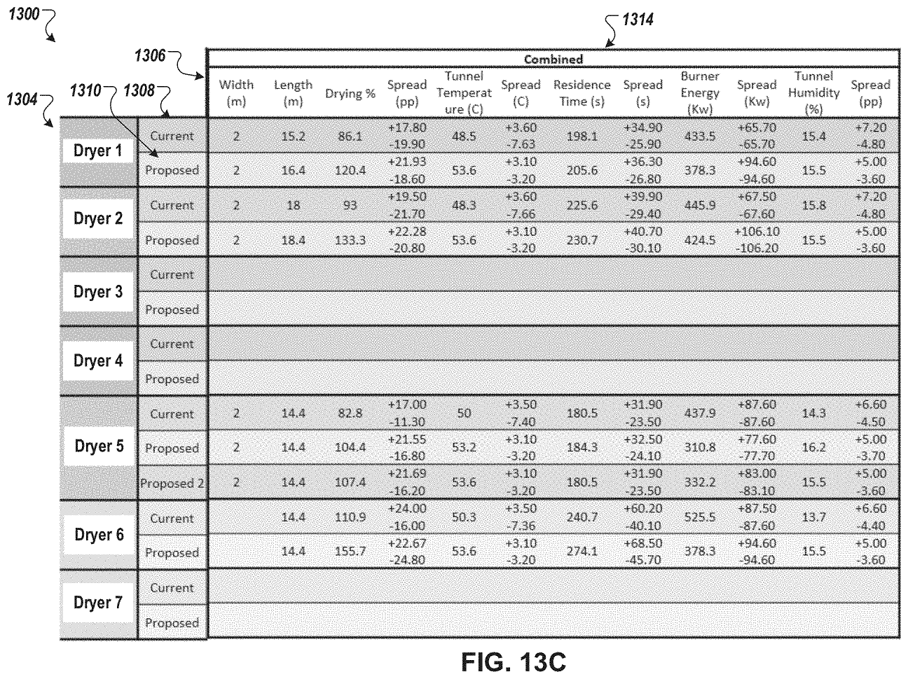

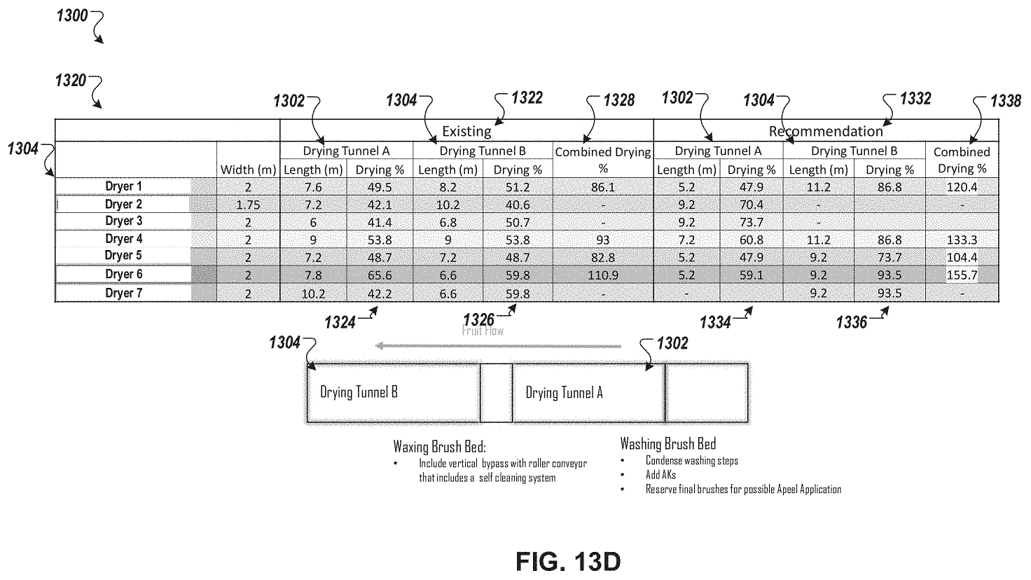

FIGS. 13A-D show an example report 1300 of proposed customization of drying equipment that has been analyzed according to implementations of the present disclosure. In this example report, the drying equipment has two drying tunnels (Tunnel A and Tunnel B), as illustrated in FIG. 13D.

Referring to FIG. 13A, the report 1300 provides current values 1308 of various parameters 1306 of each of different locations 1304 at a first drying tunnel (Tunnel A) 1302. The parameters that are presented include a dimension (width and length), a drying percentage with a deviation, a tunnel temperature with a deviation, a residence time with a deviation, a burner energy with a deviation, and a tunnel humidity with a variation. Further, the report 1300 provides proposed values 1310 of the parameters 1306 of each of the locations 1304 at the first drying tunnel (Tunnel A) 1302. Referring to FIG. 13B, the report 1300 provides current values 1308 of the parameters 1306 of each of the locations 1304 at a second drying tunnel (Tunnel B) 1312. Further, the report 1300 provides proposed values 1310 of the parameters 1306 of each of the locations 1304 at the second drying tunnel (Tunnel B) 1302. Referring to FIG. 13C, the report 1300 provides current values 1308 of the parameters 1306 of each of the locations 1304 at a combination of the first and second drying tunnels (Tunnels A and B) 1314. Further, the report 1300 provides proposed values 1310 of the parameters 1306 of each of the locations 1304 at the combination of the first and second drying tunnels (Tunnels A and B) 1414.

As shown in FIGS. 13A-C, the proposed solutions can improve several outputs, such as drying performance and energy consumption. For example, drying percentages may be increased, while overall energy consumption (e.g., by the burner) is reduced.

Referring to FIG. 13D, the report 1300 provides a comparison chart 1320 of dryness of the existing settings and the proposed settings for the drying equipment. In the illustrated example, the comparison chart 1320 shows that, under the existing settings 1322, a drying performance (percentage) 1324 through different locations 1304 of the first drying tunnel 1302, a drying performance (percentage) 1326 through the locations 1304 of the second drying tunnel 1302, and a combined drying performance (percentage) 1328 through the locations 1304. Further, the comparison chart 1320 shows that, under the recommended settings 1332, a drying performance (percentage) 1334 through the locations 1304 of the first drying tunnel 1302, a drying performance (percentage) 1336 through the locations 1304 of the second drying tunnel 1302, and a combined drying performance (percentage) 1338 through the locations 1304. An improvement can be recognized or calculated by comparing the corresponding drying performances between the existing settings and the proposed settings.

The systems described herein may utilize one or more additional or alternative drying techniques and/or devices. For example, a vertical drying tunnel can be used to implement at least part of the drying apparatus described herein. Alternatively or additionally, air knife dryers can be used to implement at least part of the drying apparatus described herein. In an example embodiment, the air knife dryers can generate curtain-like airflow (e.g., air curtain) to dry, clean, remove excess oils, liquids and dust from product being treated before or during the coating application. The air knife dryers can utilize the Coanda Effect to amplify the air up to 40 times from the inlet.

Alternatively, or additionally, the systems described herein may utilize infrared and/or radiative drying techniques. In some embodiments, infrared and/or radiative drying techniques may reduce drying times as compared to convective techniques.

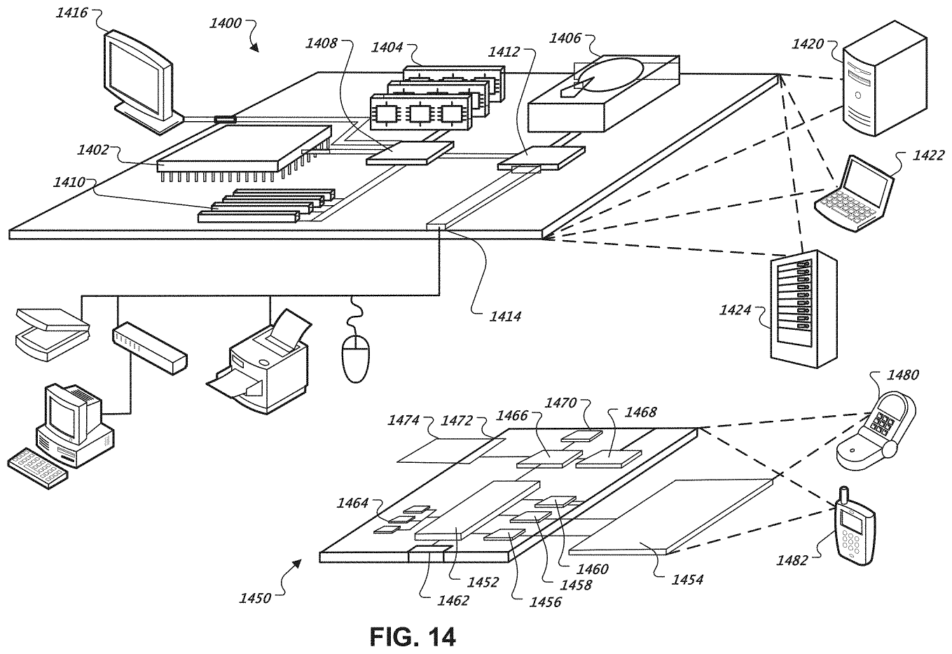

FIG.14 is a block diagram of computing devices1400, 1450 that may be used to implement the systems and methods described in this document, as either a client or as a server or plurality of servers. Computing device 1400 represents various forms of digital computers, such as laptops, desktops, workstations, personal digital assistants, servers, blade servers, mainframes, and other appropriate computers. Computing device 1450 represents various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device1406. Each of the components 1402, 1404, 1406, 1408, 1410, and 1412, are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high-speed interface 1408. In other implementations, multiple processors and/or multiple buses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1404, the storage device 1406, or memory on processor 1402.

The high-speed controller 1408 manages bandwidth-intensive operations for the computing device 1400, while the low speed controller 1412 manages lower bandwidth-intensive operations. Such allocation of functions is an example only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a micro-drive or other device, to provide additional storage. Each of the components 1450, 1452,1464, 1454, 1466, and 1468, are interconnected using various buses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT (Thin-Film-Transistor Liquid Crystal Display) display or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provide in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 1474 may provide extra storage space for device 1450 or may also store applications or other information for device 1450. Specifically, expansion memory 1474 may include instructions to carry out or supplement the processes described above and may include secure information also. Thus, for example, expansion memory 1474 may be provide as a security module for device 1450 and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memoryl474, or memory on processor 1452 that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, WiFi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Additionally, computing device 1400 or 1450 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

### EXAMPLES

The heated convection-based systems described herein were applied to drying a coating agent applied on the surfaces of various items, including apples, cucumbers, limes, and mangos. Performance results across various metrics for each of the items is described below.

Example 1

### Apples

Three samples of at least 100 apples 100) were treated with a common coating agent application. The three samples were exposed to independent drying conditions including temperatures ranging from 70° C. to 75° C., and residence times between 1 minute (min) 40 seconds (sec) to 7 min 15 sec.

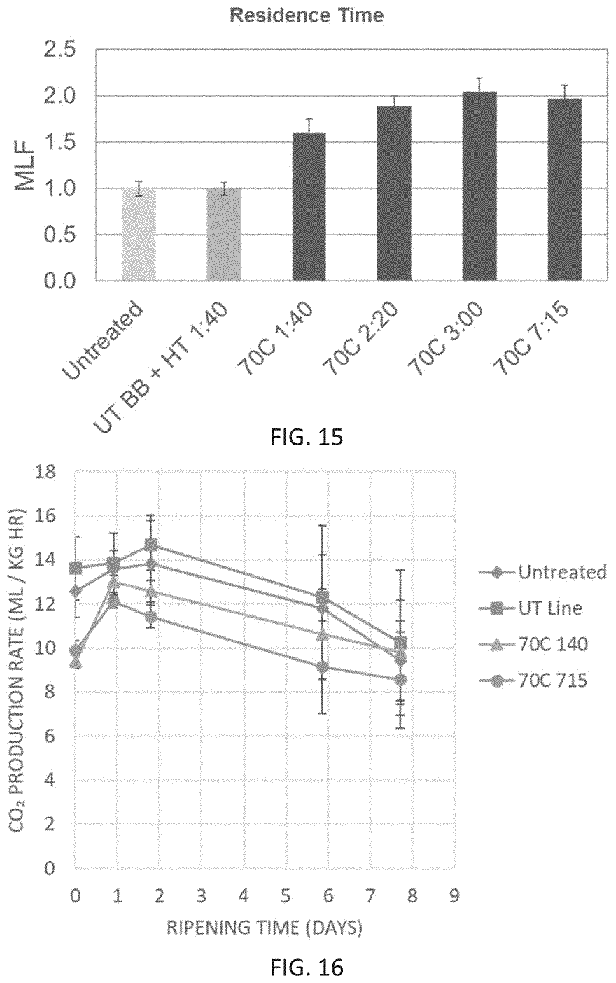

FIG. 15 is a bar chart comparing mass loss factor (MLF) to treatment conditions including untreated (UT) and heat treatment (HT). The heat treatment results of FIG. 15 were conducted at 70° C. for varying residence times, from 1 min 40 sec (1:40) to 7 min 15 sec (7:15). The MLF increased with increasing temperature from 70° C. to 75° C. (not shown), and performance increased as residence time increased.

FIG. 16 is a scatter plot chart comparing respiration (e.g., CO₂ production rate) to ripening time (days). Respiration was not negatively affected by extended residence time in head tunnel.

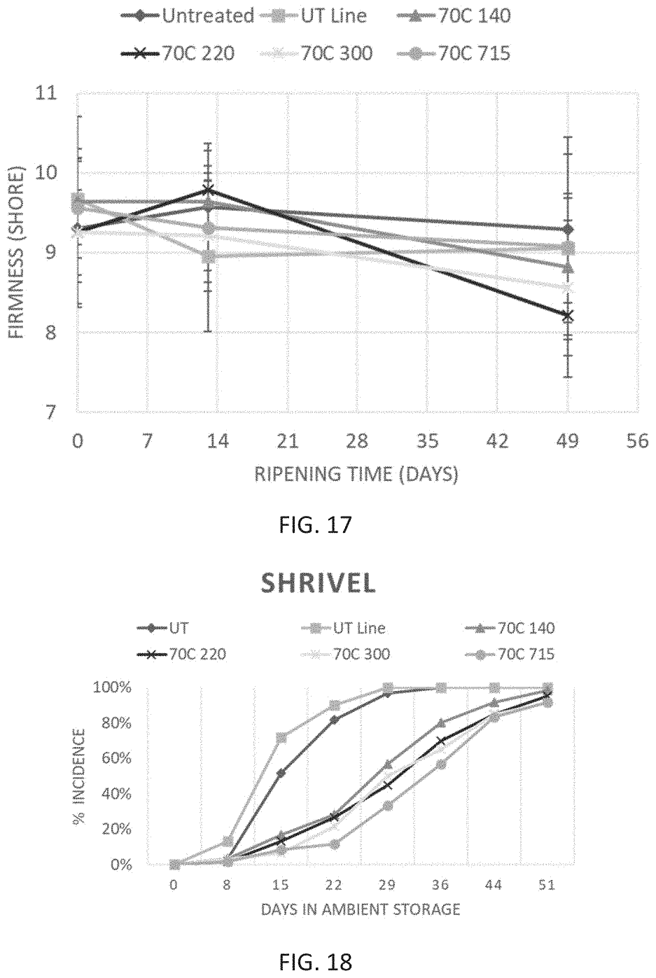

FIG. 17 is a scatter plot chart comparing firmness (Shore durometer) to ripening time (days) including untreated (UT) and heat treatment (70° C.). The heat treatment results of FIG. 17 were conducted at 70° C. for varying residence times, from 1 min 40 sec (1:40) to 7 min 15 sec (7:15). Extended residence time for coated samples did not have a negative impact on quality metrics such as firmness (FIG. 17), decay, lenticel damage, shrivel and scald.

FIG. 18 is a scatter plot chart comparing % incidence of shrivel to days of storage at ambient conditions including untreated (UT) and heat treatment (70° C.). The heat treatment results of FIG. 18 were conducted at 70° C. for varying residence times, from 1 min 40 sec (1:40) to 7 min 15 sec (7:15). Shrivel was not negatively impacted by long drying tunnel exposure.

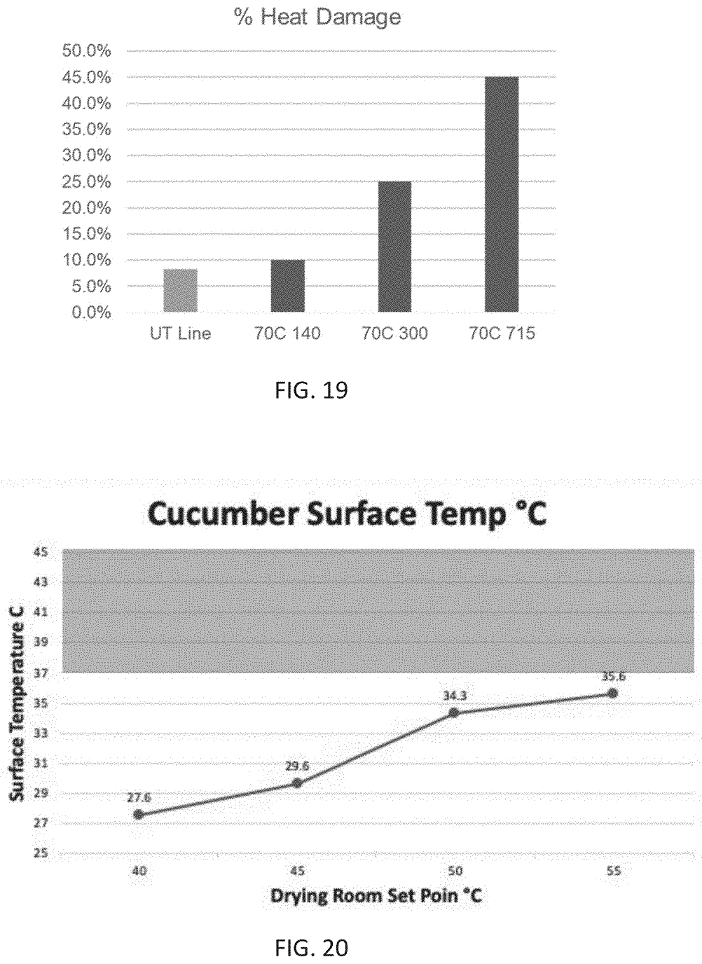

FIG. 19 a bar chart comparing % heat damage to treatment conditions including untreated (UT) and heat treatment (70 C). The % heat damage results of FIG. 19 were conducted at 70° C. for varying residence times, from 1 min 40 sec (1:40) to 7 min 15 sec (7:15). For example, drying time of <2 minutes at 70° C. or 75° C. does not result in excessive heat damage. Over 3 minutes at 70° C. does result in heat damage.

### Example 2

### Cucumbers

Samples of cucumbers were treated with a common coating agent application and exposed to drying conditions. FIG. 20 is a scatter plot chart comparing cucumber surface temperature (° C.) to drying room temperature set point (° C.). Lower drying tunnel temperature decreases cucumber surface temperature leaving the drying room including the drying tunnel. With greater treatment times, likelihood of line stoppage increases.

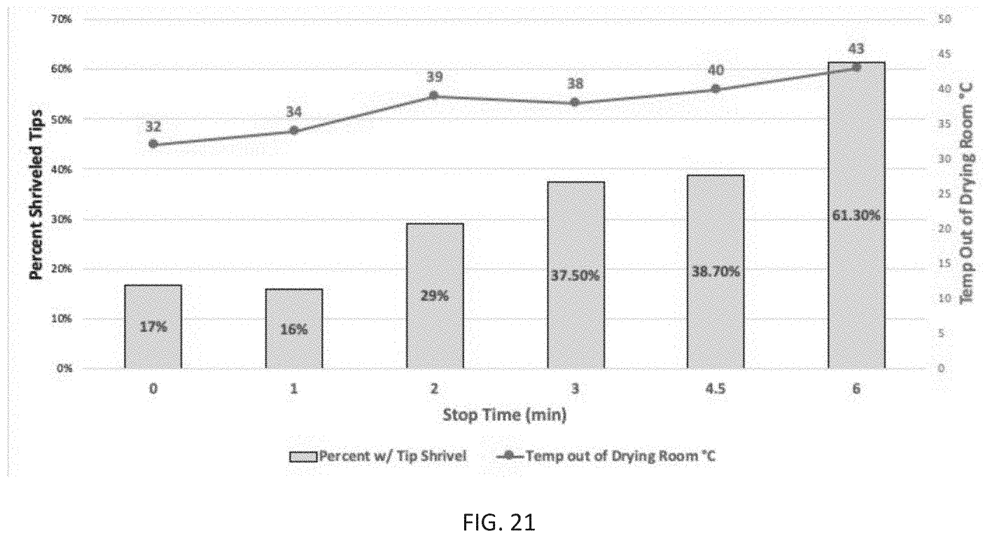

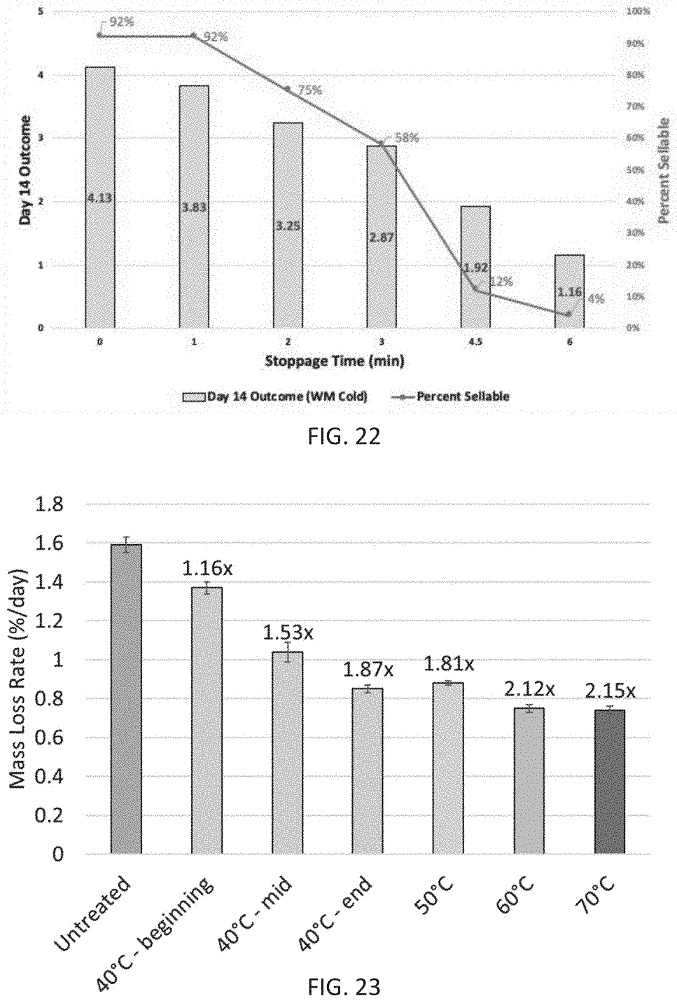

FIG. 21 is a bar chart comparing percent shriveled tips (bars) and temperature outside of the drying room (° C.) (line) to stoppage time (min). Stoppage time greater than 1 min increases incidence of tip shriveling, and decreases day 14 outcomes through a simulated supply chain, at a set point of 55° C. (FIGS. 21 and 22). FIG. 22 is a bar chart comparing percent shriveled tips at day 14 of FIG. 21 (bars) and % samples that are sellable (line) to stoppage time (min). One side of cucumbers dry with set points as low as 45° C.

### Example 3

### Limes

Samples of limes were treated with a common coating agent application and exposed to drying conditions to determine the effect of heat tunnel temperature on performance. The three samples were exposed to drying conditions including variable temperature conditions in a drying tunnel. The samples underwent a residence time of 2 min 9 sec.

Increased performance with increased run time under fixed parameters indicates performance may benefit from saturation of the brushbed for a longer time prior to run. FIG. 23 is a bar chart comparing mass loss rate (%/day, bars) and temperature outside of the drying room (° C.) (line) to treatment conditions including untreated (UT) and heat treated samples. The heat treatment results of FIG. 23 were conducted at 40° C., 50° C., 60° C., and 70° C. Performance (e.g., reduced mass loss rate) increases with tunnel temperatures.

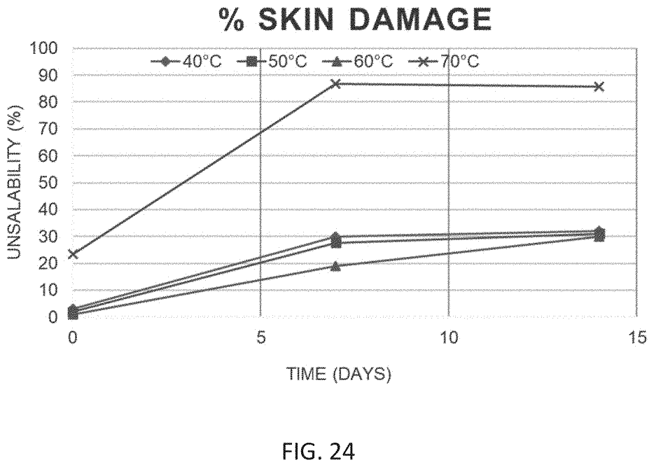

Skin damage was assessed post-drying. FIG. 24 is a scatter plot chart comparing % unsalability of samples to time post-treatment (days). Samples were exposed to temperature conditions of 40° C., 50° C., 60° C., and 70° C. and assessed at 0, 7, and 14 days post-treatment. Temperature conditions of 40° C., 50° C., and 60° C. present no quality issues over time.

### Example 4

### Mangos

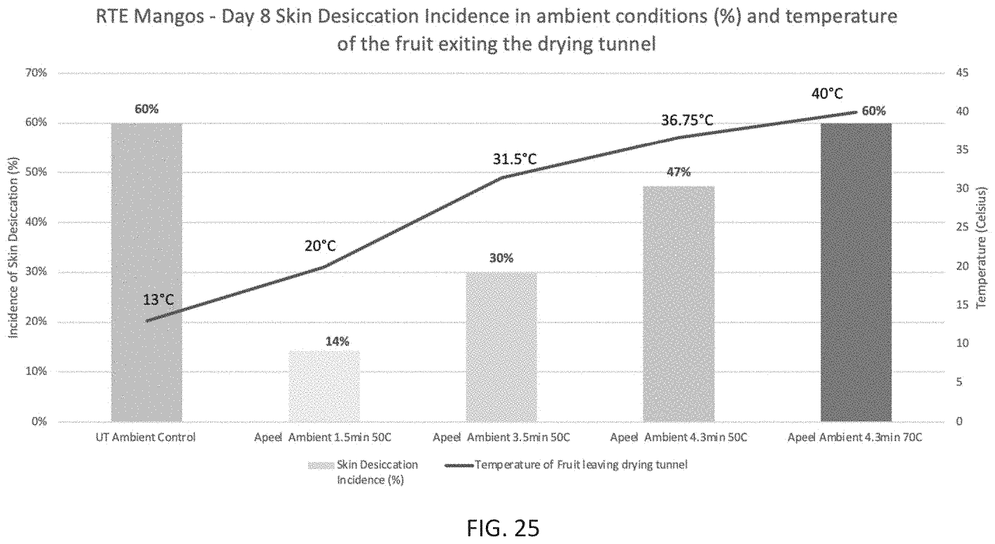

Samples of mangos were treated with a common coating agent application and exposed to drying conditions to determine the effect of heat tunnel temperature on skin desiccation. FIG. 25 is a bar chart comparing incidence of skin desiccation (% of samples, bars) and temperature of the fruit existing the drying tunnel (° C., line) to treatment conditions including untreated (UT) and heat treated samples. The heat treatments were conducted at 50° C. or 70° C. A correlation between higher fruit temperature leaving the drying tunnel and increased skin desiccation incidence, e.g., lower performance, as shown in FIG. 25.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for treating, using a treatment apparatus, a plurality of items with a coating mixture, the method comprising:
identifying first data associated with the treatment apparatus;
identifying second data associated with the plurality of items;
identifying third data associated with the coating mixture;
determining coating requirements that represent desired properties of coating over the plurality of items;
determining treatment processing parameters based on the first data, the second data, the third data, and the coating requirements;
setting the treatment apparatus based on the treatment processing parameters; and
operating the treatment apparatus to treat the plurality of items with the coating mixture.

2. The method of claim 1, wherein the coating mixture includes a coating agent, a water-based solution, and a solvent.

3. The method of claim 2, wherein the treatment apparatus comprises:
a conveyor bed configured to support the plurality of items and being rotatable to convey the plurality of items thereon;
one or more sprayer configured to apply the coating mixture to the plurality of items on the conveyor bed;
one or more blower configured to blow air onto the plurality of items such that the solvent is at least partially removed from the plurality of items and a protective coating of the coating agent is formed over the plurality of items; and
a heat exchanger configured to heat the air at a predetermined temperature higher than an ambient temperature.

4. The method of claim 3, wherein the first data includes at least one of a mass throughput, the ambient temperature, an ambient humidity, a post heat exchanger temperature, a post heat exchanger humidity, an item path air velocity, a conveyor length, a conveyor width, or a heated chamber height.

5. The method of claim 4, wherein the second data includes at least one of a geometry of the items, a density of the items, a thermal conductivity of the items, a skin thickness of the items, a water content of the items, a composition of the items, or a surface area of the items.

6. The method of claim 5, wherein the third data includes the third data includes at least one of an adherence rate, a dynamic viscosity, a mass diffusivity, a specific heat capacity, a latent heat of vaporization, a thermal conductivity, a density, a heat transfer coefficient, or a mass transfer coefficient.

7. The method of claim 1, wherein determining treatment processing parameters comprises:
setting a residence time through the treatment apparatus;
monitoring the treatment processing parameters;
determining whether variables associated with the treatment apparatus meet a threshold, the threshold representative of the coating requirements; and
identifying, based on the variables meeting the threshold, the variables as the treatment processing parameters.

8. The method of claim 1, wherein determining treatment processing parameters comprises:
predicting the treatment processing parameters based on a treatment processing model with inputs of the first data, the second data, the third data, and the coating requirements.

9. The method of claim 1, wherein determining treatment processing parameters comprises:
determining a treatment processing model;
fitting the treatment processing model based on the first data, the second data, the third data, and the coating requirements; and
predicting the treatment processing parameters based on the fitted treatment processing model.

10. The method of claim 8, further comprising:
verifying the treatment processing model based on the operation of the treatment apparatus.

11. The method of claim 1, wherein the treatment apparatus includes a heated convection-based drying apparatus.

12. The method of claim 2, wherein the coating mixture comprises a monoglyceride and fatty acid salt.

13. The method of claim 12, wherein the coating mixture comprises between 50% and 99% monoglyceride, and between 1% and 50% fatty acid salt.

14. The method of claim 7, wherein the residence time of the items is between 150 seconds and 180 seconds.

15. The method of claim 1, wherein the treatment processing parameters include an average system temperature, the average system temperature greater than 65° C.

16. The method of claim 1, wherein the treatment processing parameters include a product path air velocity, the product path air velocity between 3 m/s and 6 m/s.

17. The method of claim 1, wherein the treatment processing parameters include a relative humidity within the apparatus, the relative humidity less than 15%.

18. The method of claim 1, wherein the coating requirement includes a coating thickness between 0.1 microns and 5 microns.

19. The method of claim 18, wherein the coating requirement includes one of a coating mosaicity requirement, or a bilayer stacking mosaicity.

20. A method for treating an item with a coating mixture, comprising:
identifying operational parameters associated with a drying tunnel;
identifying a desired coating requirement;
determining optimal drying tunnel parameters based on the operational parameters and the desired coating requirements; and
operating the drying tunnel based on the optimal drying tunnel parameters.

21. The method of claim 20, wherein the coating requirement includes one of a coating thickness, or a coating mosaicity.

22. A treatment system for drying coated products, comprising:
a drying tunnel controller;
a drying tunnel having a first end that receives coated products and a conveyor that advances the coated products towards a second end, the drying tunnel controlled by the drying tunnel controller to maintain one or more treatment processing parameters of the drying tunnel within a predetermined range, the treatment processing parameters including an average system temperature and a conveyer speed, the conveyor speed based at least in part on a temperature of the products before entering the first end of the drying tunnel.

23. The treatment system of claim 22, wherein the one or more treatment processing parameters include an average system temperature, wherein the average system temperature is greater than 65° C.

24. The treatment system of claim 22, wherein the conveyor speed is controlled to provide a product residence time within the drying tunnel between 90 seconds and 240 seconds.

25. The treatment system of claim 22, wherein the one or more treatment processing parameters includes a product path air velocity, wherein the product path air velocity is maintained between 3 m/s and 6 m/s.

26. The treatment system of claim 22, wherein the one or more treatment processing parameters includes an average relative humidity, wherein the average relative humidity is controlled to be less than 15%.

27. The treatment system of claim 22, wherein the treatment processing parameters are selected based on one or more of a product geometry, a product density, a product thermal conductivity, a product skin thickness, a product water content, a product composition, and a product surface area.

28. The treatment system of claim 22, wherein the coated products comprise a liquid coating, the liquid coating comprising a water-based solution, comprising a monoglyceride and fatty acid salt.

29. The treatment system of claim 28, wherein the liquid coating comprises between 50% and 99% monoglyceride, and between 1% and 50% fatty acid salt.

30. The treatment system of claim 22, wherein the treatment processing parameters are configured to form a dried coating on the products having a thickness between 0.1 microns and 5 microns that exhibits bilayer stacking mosaicity.
